(19) United States
(12) Patent Application Publication
(10) Pub. No.: US 2018/0309919 A1
(43) Pub. Date: Oct. 25, 2018

(54) METHODS AND APPARATUS FOR CONTROLLING EXPOSURE AND SYNCHRONIZATION OF IMAGE SENSORS

(71) Applicant: QUALCOMM Incorporated, San Diego, CA (US)

(72) Inventors: Htet Naing, San Diego, CA (US); Kalin Atanassov, San Diego, CA (US); Stephen Michael Verrall, Carlsbad, CA (US)

(21) Appl. No.: 15/491,874

(22) Filed: Apr. 19, 2017

(51) Int. Cl. H04N 5/235; H04N 5/225; H04N 5/376; H04N 5/33; H04N 9/04

(52) U.S. Cl. CPC H04N 5/2353; H04N 5/2258; H04N 5/374; H04N 5/332; H04N 9/045; H04N 5/3765

(57) ABSTRACT

An aspect of this disclosure is an apparatus for capturing images. The apparatus comprises a first image sensor, a second image sensor, and at least one controller coupled to the first image sensor and the second image sensor. The controller is configured to determine a first exposure time of the first image sensor and a second exposure time of the second image sensor. The controller is further configured to control an exposure of the first image sensor according to the first exposure time and control an exposure of the second image sensor according to the second exposure time. The controller also determines a difference between the first and second exposure times and generates a signal for synchronizing image capture by the first and second image sensors based on the determined difference between the first and second exposure times.

### BACKGROUND

### Field

This disclosure generally relates to providing automatic exposure control in photographic and/or other image capture devices. More specifically, this disclosure relates to controlling synchronization and exposure of asymmetric sensors in an imaging device.

### Description of the Related Art

Users often experience events which they would like to capture in a photograph or video, and view at a later date and/or time, for example, a child's first steps or words, a graduation, or a wedding. Often, these events may be near-static and their occurrence generally predictable (e.g., a wedding, a graduation, a serene landscape, or a portrait) and may be easily captured using an imaging system, e.g., a camera, video recorder, or smartphone. For such moments, there may be sufficient time for the imaging system to determine and adjust proper exposure settings to capture the moment event. However, sometimes capturing scenes with the proper exposure may present a challenge, especially if the imaging device utilizes multiple asymmetric sensors as part of its imaging system.

Even when the user of the equipment captures an image of a scene at the proper moment utilizing the imaging device with asymmetric sensors, the asymmetric sensors may not be synchronized in their operation. For example, traditional synchronization methods used in symmetric sensor devices may not work for asymmetric sensors (e.g., sensors having different resolution, pixel sizes, line time, spectral response, etc.). Therefore, alternative methods must be utilized to synchronize asymmetric sensors to allow the imaging device utilizing the asymmetric sensors to ensure synchronized operation of the sensors with proper exposure control. Accordingly, systems and methods to control exposure of and synchronization between asymmetric sensors of an imaging system would be beneficial.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of the various embodiments provide advantages that include improved determination of exposure parameters for an imaging system.

An aspect of this disclosure is an apparatus for capturing images. The apparatus comprises a first image sensor, a second image sensor, and at least one controller. The at least one controller is coupled to the first image sensor and the second image sensor. The at least one controller is configured to determine a first exposure time of the first image sensor. The at least one controller is also configured to control an exposure of the first image sensor according to the first exposure time. The at least one controller is further configured to determine a second exposure time of the second image sensor and control an exposure of the second image sensor according to the second exposure time. The at least one controller is also configured to further determine a difference between the first exposure time and the second exposure time. The at least one controller is further configured to also generate a signal for synchronizing image capture by the first image sensor with image capture by the second image sensor based on the determined difference between the first exposure time and the second exposure time.

Another aspect of this disclosure is a method of capturing images via an image capture device. The method comprises determining a first exposure time of a first image sensor of the device and controlling an exposure of the first image sensor according to the first exposure time. The method also comprises determining a second exposure time of a second image sensor of the device and controlling an exposure of the second image sensor according to the second exposure time. The method further comprises determining a difference between the first exposure time and the second exposure time. The method further also comprises generating a signal for synchronizing image capture by the first image sensor with image capture by the second image sensor based on the determined difference between the first exposure time and the second exposure time.

Another aspect of this disclosure is an apparatus for capturing images. The apparatus comprises means for determining a first exposure time of a first image sensor of the device and means for controlling an exposure of the first image sensor according to the first exposure time. The apparatus further comprises means for determining a second exposure time of a second image sensor of the device and means for controlling an exposure of the second image sensor according to the second exposure time. The apparatus also comprises means for determining a difference between the first exposure time and the second exposure time. The apparatus further also comprises means for generating a signal for synchronizing image capture by the first image sensor with image capture by the second image sensor based on the determined difference between the first exposure time and the second exposure time.

An additional aspect of this disclosure is a non-transitory, computer readable storage medium. The storage medium comprises code executable to determine a first exposure time of a first image sensor of the device and control an exposure of the first image sensor according to the first exposure time. The storage medium also comprises code executable to determine a second exposure time of a second image sensor of the device and control an exposure of the second image sensor according to the second exposure time. The storage medium further comprises code executable to determine a difference between the first exposure time and the second exposure time. The storage medium further also comprises code executable to generate a signal for synchronizing image capture by the first image sensor with image capture by the second image sensor based on the determined difference between the first exposure time and the second exposure time.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Throughout the drawings, similar symbols typically identify similar components, unless context dictates otherwise. Note that the relative dimensions of the following figures may not be drawn to scale.

FIG. 1 is a diagram illustrating an example of an image capture device capturing an image of a field of view (FOV), according to some embodiments.

FIG. 2A is a block diagram illustrating pixel sizes of the NIR sensor and the RGB sensor of FIG. 1, in accordance with an exemplary embodiment.

FIG. 2B is a signal timing diagram with corresponding exposure windows for the NIR sensor and the RGB sensor of FIGS. 1 and 2A, the sensors overlapping at the end of the exposure windows for the first lines of each respective sensor.

FIG. 2C is another signal timing diagram with corresponding exposure windows for the NIR sensor and the RGB sensor of FIGS. 1 and 2A, the sensors overlapping at the ends of the exposure windows for corresponding lines of each respective sensor.

FIG. 2D is a third signal timing diagram with corresponding exposure windows for the NIR sensor and the RGB sensor of FIGS. 1 and 2A, the sensors overlapping at the centers of the exposure windows for corresponding lines of each respective sensor.

FIG. 3 is a block diagram illustrating an example of one embodiment of an image capture device 302 (e.g., camera 302) comprising asymmetric sensors, in accordance with an exemplary embodiment.

FIG. 4 illustrates an example of an exposure and synchronization timing diagram of an image capture device comprising symmetric sensors, in accordance with an exemplary embodiment.

FIG. 5A illustrates an example of an exposure and synchronization timing diagram of the image capture device of FIG. 1 where the exposures of the asymmetric sensors are equal, in accordance with an exemplary embodiment.

FIG. 5B illustrates an example of an exposure and synchronization timing diagram of the image capture device of FIG. 1 where the exposure of a first asymmetric sensor is less than an exposure of a second asymmetric sensor, in accordance with an exemplary embodiment.

FIG. 5C illustrates an example of an exposure and synchronization timing diagram of the image capture device of FIG. 1 where the exposure of the first asymmetric sensor is greater than the exposure of the second asymmetric sensor, in accordance with an exemplary embodiment.

FIG. 6 is a flow diagram indicating exposure and timing control in the asymmetric sensors of the image capture device of FIG. 1, according to an exemplary embodiment.

FIG. 7 is a state diagram illustrating timing adjustment in the asymmetric sensors of the image capture device of FIG. 1, according to an exemplary embodiment.

FIG. 8 is a flowchart illustrating an example of a method for controlling and synchronizing asymmetric sensors in the image capture device of FIG. 1, according to an exemplary embodiment.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure may be thorough and complete, and may fully convey the scope of the disclosure to those skilled in the art. The scope of the disclosure is intended to cover aspects of the systems, apparatuses, and methods disclosed herein, whether implemented independently of, or combined with, any other aspect of the disclosure. For example, an apparatus may be implemented or a method may be practiced using any number of the aspects set forth herein. In addition, the scope of embodiments of the disclosure, including those described herein, is intended to cover such an apparatus or method which is practiced using other structure, functionality, or structure and functionality in addition to or other than the various aspects of the embodiments set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to various imaging and photographic technologies, system configurations, computational systems, flash systems, and exposure determination systems. The Detailed Description and drawings are intended to be illustrative of the disclosure of embodiments, rather than limiting.

In photography, when a user is using an imaging system (or camera) in a manual mode, the user may actively control what the imaging system is focused on and may select various characteristics (e.g., aperture, shutter speed, “film” speed) that control the exposure. This allows the imaging system to capture an image nearly instantaneously when the user activates a control interface to capture an image. However, when an imaging system is used in an automatic focus (“autofocus”) and an automatic exposure mode, before an image is captured the imaging system is configured to determine a correct exposure and perform an autofocus process. In some embodiments, manual mode may provide the user options to establish synchronization settings and delays for the sensors of the imaging system.

When dealing with imaging systems utilizing multiple symmetric (same type/configuration) sensors (e.g., red-green-blue (RGB) sensors or near-infrared (NIR) sensors), one of the multiple sensors may be designated as a master sensor and the remaining sensor(s) may be designated as slave sensors. The slave sensors may be synchronized to the master sensor, where each read signal of the slave sensors is synchronized to a read signal of the master sensor. Since the sensors are symmetric, each of the sensors has the same resolution, pixel size, line time, etc. Accordingly, exposure of the multiple symmetric sensors may be synchronized based on a signal from the master sensor with consideration of delays, etc. needed to align exposures of the sensors.

As image capture devices advance and different applications and architectures are developed, different combinations and types of sensors may be utilized. For example, an active-light based 3D scanner may utilize an RGB sensor in combination with an NIR sensor. However, these sensors may be asymmetric, meaning that they are different with regard to operations and specifications. For example, the RGB and NIR sensors may have different resolutions, pixel sizes, spectral responses, etc. Additionally, the RGB sensor may be reliant upon lighting conditions of the field of view (FOV) or the scene being captured, while the NIR sensor may be reliant upon NIR light that is projected by an NIR emitter and NIR light that is reflected from a target object in the FOV or scene and received by the NIR sensor. Accordingly, the two sensors respond to two different and independent lighting and environmental conditions, which affect the exposure requirements and times of the RGB sensor and the NIR sensor differently. The RGB sensor exposure time may vary based on lighting conditions at the target object and the NIR sensor exposure time may vary based on the reflected NIR light from the target object. The exposure times may thus be different for the two sensors based on different conditions, as shown in Table 1 below.

TABLE 1

| Distance | Lighting Condition | NIR Exposure | RGB Exposure |
|---|---|---|---|
| Close | Good | Short | Short |
| Close | Poor | Short | Long |
| Far | Good | Long | Short |
| Far | Poor | Long | Long |

For example, as shown in Table 1, for the RGB sensor, the exposure time may be short regardless of distance between the target object and the RGB sensor when the lighting conditions of the target object are good but long when the lighting conditions are poor, regardless of the distance. On the other hand, the NIR sensor exposure time may be short when the target object and the NIR sensor are in close proximity, regardless of lighting conditions, and long when the target object and the NIR sensor are far apart, regardless of lighting conditions. In some implementations, the “close” and “far” distances may be relative to the type of image capture taking place. For example, in macro image capture, “close” and “far” may both relate to distances under one foot. In some embodiments, “close” may be within one meter and far may be beyond two meters. In other embodiments, other distances may be used for one or both of the “close” or “far” distances. Other types of sensors may have corresponding exposure times that are different from those listed here.

In a CMOS sensor using electronic rolling shutter, individual lines of a frame are captured one at a time. Accordingly, exposure of each line of the frame starts and ends at different times. Individual reset and read signals are generated for each line by the sensor. A periodicity or timing of the read signals (corresponding to when the data accumulated in each line of the sensor during exposure is read out) may be maintained across all lines of the frame while the periodicity or timing of the reset signal may be adjusted based on desired exposure levels of each line within a frame. Assuming the reset signal periodicity or timing is maintained, exposure of a subsequent line begins at a time T_{HTS} after the start of the current line, where T_{HTS} is a total horizontal time needed to read out the data in the current line. The exposure time of each line and the T_{HTS} for each line may be determined by parameters of the sensor. Accordingly, different (or asymmetric) sensors may have different exposure times or T_{HTS} times.

Synchronization is needed to ensure that the asymmetric CMOS sensors are capturing the same target object at the same time. Accordingly, there may be two values on which the synchronization is based: the exposure times of the sensors and the overlap desired. Synchronization of the two asymmetric CMOS sensors may correspond to ensuring that the two asymmetric sensors expose each line or corresponding lines of the target frame at the same time. For example, in an embodiment of an imaging device, a master sensor may have a resolution that is three times the resolution of a slave sensor for the same field of view (FOV). In such an embodiment, the master sensor may have three times the number of pixel lines to expose and read out as the slave sensor. Accordingly, the two sensors must be synchronized so that corresponding portions of the FOV are exposed and read out at similar times by both the master and the slave sensors. If synchronization is not used, then the slave sensor, having the lower resolution, may complete its exposure and reading out of the FOV before the master sensor, which may cause problems of capturing elements that exist in those portions of the frame at particular moments (e.g., artifacts, etc.).

Additionally, the asymmetric sensors may be synchronized to overlap exposure of a particular portion of the line (e.g., a beginning, middle, or end portion of the line). If the exposure overlap is desired at the beginning of the line, the asymmetric sensors may be synchronized to begin exposure at the beginning of the line at the same time. If the exposure overlap is desired at the middle of the line, then the asymmetric sensors may be synchronized to overlap exposure at the middle of the line at the same time. If the exposure overlap is desired at the end of the line, then the asymmetric sensors may be synchronized to overlap exposure at the end of the line at the same time. In some embodiments, the exposure overlay location may be determined by the image capture device. By using the present disclosure, the multiple sensors of the image capture device may maintain synchronization amongst each other with reference to a determined or selected overlap region of the exposure window. In some embodiments, the image capture device may determine or select a preferred overlap for the multiple sensors based on one or more scene or imaging parameters. In some embodiments, the use may select or adjust the overlap manually. In some embodiments, the user may determine when or where exposure overlap is desired.

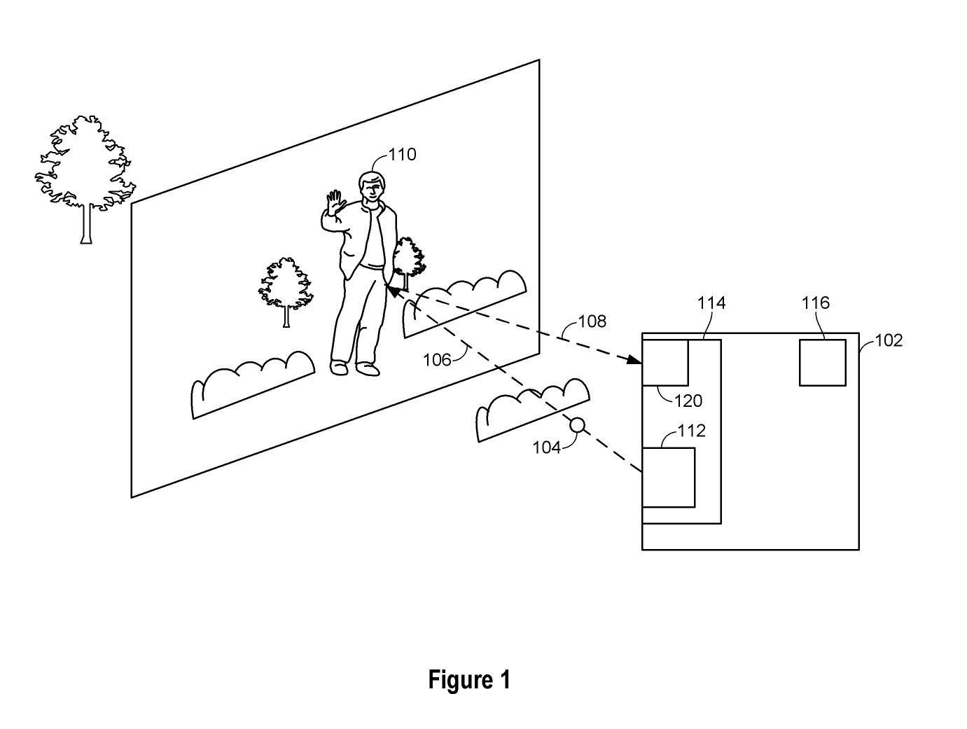

FIG. 1 is a diagram illustrating an example of an image capture device 102 capturing an image of a field of view (FOV), according to some embodiments. In some embodiments, the image capture device 102 may comprise the 3D scanner mentioned above. Accordingly, the image capture device 102 is a camera (or scanner) that includes an NIR sensor 114 and an RGB sensor 116. For clarity of description, both an image capture device and a camera will be referred to as the “camera” 102 in the context of this description. The camera 102 may be any device capable of capturing a still or moving image, regardless of format (digital, film, etc.) or type (video camera, still camera, web camera, etc.). The camera 102 is configured to capture images using both the NIR sensor 114 and the RGB sensor 116. For example, in some embodiments, the NIR sensor 114 and the RGB sensor 116 may generate images that are combined to form 3D images for the 3D scanner of a target object 110 or target scene. For clarity of description, both a target scene and a target object 110 will be referred to as the “target object” 110 in the context of being the subject matter that the camera 102 is focused on.

As shown, the NIR sensor 114 comprises a light source (e.g., light emitter) 112. The light emitter 112 may be incorporated in the camera 102 or coupled to the camera 102. In some embodiments, the light emitter 112 is separate from the camera 102, e.g., it is not integrated into or structurally attached to the camera 102.

The embodiment of FIG. 1 illustrates emitted NIR light 104 from the light emitter 112 propagating along a path 106 that represents the path of light from the light emitter 112 to the target object 110. FIG. 1 also illustrates a reflected light 108 which may represent the light or the reflected path of the light that illuminates the target object 110 (for example, from light emitter 112) and reflects from the target object 110 to a light sensor 120 of the NIR sensor 114. In some embodiments, the light emitter 112 and the light sensor 120 may be two components that are configured to operate together, instead of being part of a single component NIR sensor 114. While the light emitter 112 and the light sensor 120 may be two distinct components and/or systems, for the purposes of this disclosure, they will be discussed as forming the NIR sensor 114.

The RGB sensor 116 may be configured to capture an image of the target object 110 based on ambient light or light projected by a flash (not shown). In some embodiments, the flash may be integrated with the camera 102. In some embodiments, the flash may be separate from the camera 102.

In some embodiments, one or both of the NIR sensor 114 and the RGB sensor 116 may be replaced with one or more other sensors so long as there are two asymmetric sensors in the camera 102. In some embodiments, the camera 202 may include W/T sensor modules three or more sensors or cameras having different fixed optical lengths, a combination of one or more of each of RGB and monochrome sensors (for example, Qualcomm Clear Sight technology or modules), modules having differently sized sensors, or any other combination of image sensors and/or modules. The image sensors may not be identical, with non-identical sensors having different characteristics in various embodiments. Images captured by both the sensors may be used fused together to form a combined snapshot, combining the perspectives of both the sensors.

For the camera 102 incorporating the asymmetric sensors to operate effectively (e.g., to be able to generate a high quality 3D image based on individual images from the two asymmetric sensors), the two asymmetric sensors (e.g., the NIR sensor 114 and the RGB sensor 116) may be operated in a synchronized manner. However, the traditional sensor synchronization may not apply to the asymmetric sensors because the exposure times of the asymmetric sensors may not track each other.

Since the exposure times between the NIR sensor 114 and the RGB sensor 116 are not the same, each sensor may be configured to perform auto exposure to ensure that each sensor produces a best quality image that results in the best quality combined image. Accordingly, each of the NIR sensor 114 and the RGB sensor 116 may include local exposure control by which each sensor determines its exposure value. The exposure values of the NIR sensor 114 and the RGB sensor 116 are compared, and, based on the comparison, a delay value is generated and implemented for one of the two NIR and RGB sensors 114 and 116, respectively. In some embodiments, the exposure value for each sensor may correspond to an amount of time that passes from a reset of each line of the sensor to the readout command of each line of the sensor or an exposure time for each line of the sensor.

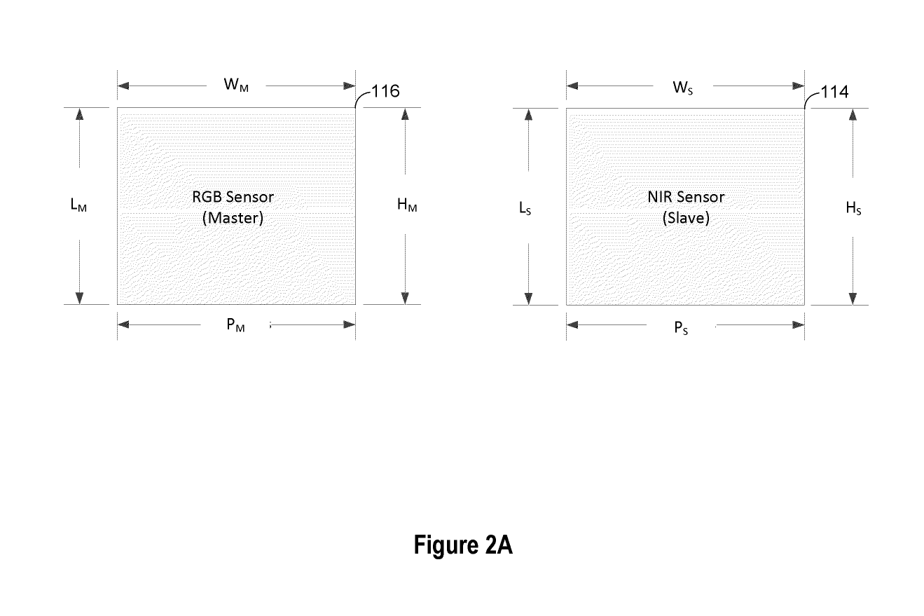

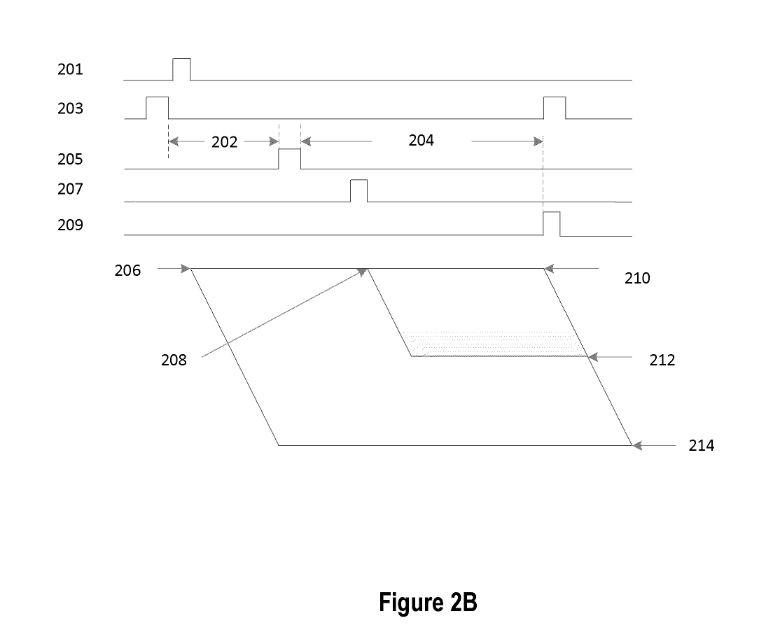

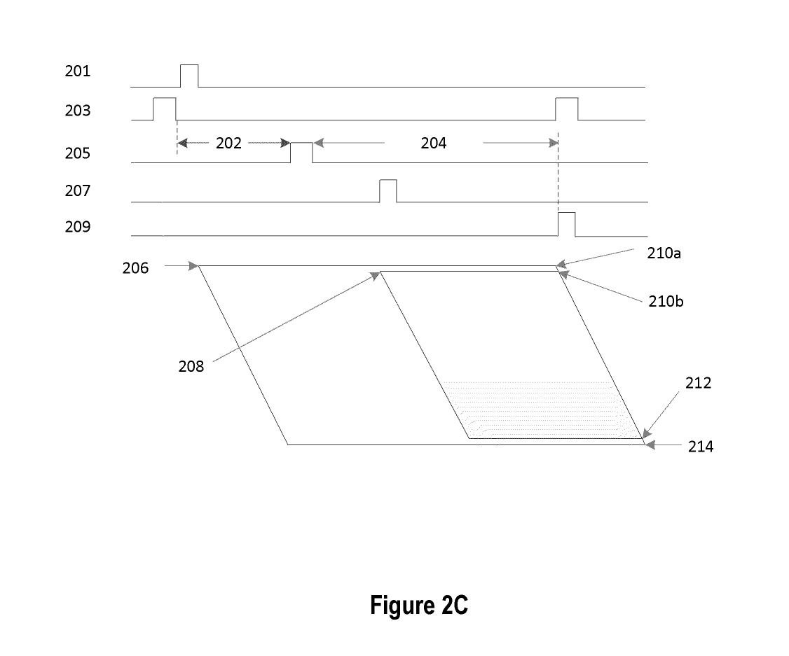

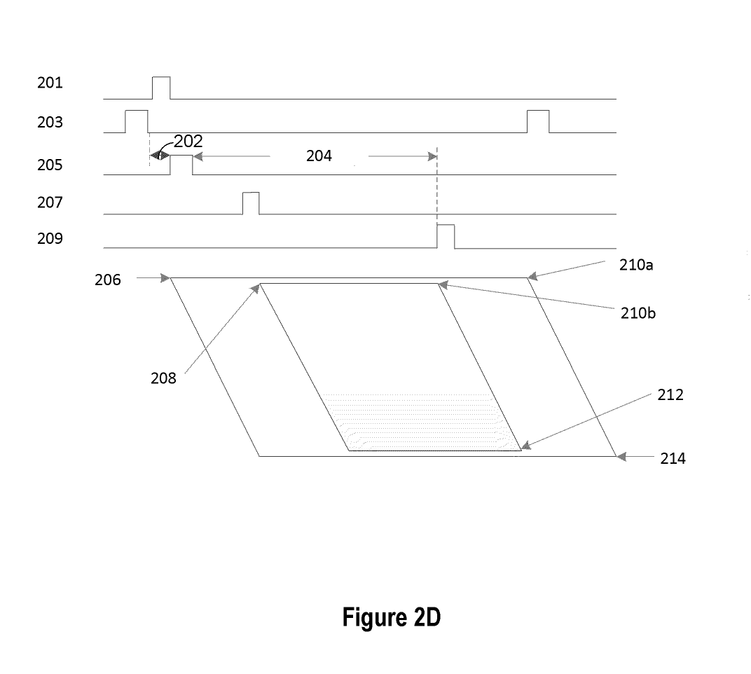

FIG. 2A is a block diagram illustrating pixel sizes of the NIR sensor 114 and the RGB sensor 116 of FIG. 1, in accordance with an exemplary embodiment. The NIR sensor 114 and the RGB sensor 116 as shown may have the same physical size, e.g., both having widths of 3.84 mm and heights of 2.16 mm. However, the NIR sensor 114, designated as the slave sensor, may comprise 360 lines that each comprise 640 pixels, while the RGB sensor 116, designated as the master sensor, may comprise 1080 lines that each comprise 1920 pixels. Accordingly, the master RGB sensor 116 may have a resolution that is three times greater than the slave NIR sensor 114 and pixel sizes that are three times smaller than the slave NIR sensor 114. Assuming both the RGB sensor 116 and the NIR sensor 114 use the same or identical lens systems, both the sensors will have the same field of view (FOV).

FIG. 2B is a signal timing diagram with corresponding exposure windows for the NIR sensor 114 and the RGB sensor 116 of FIGS. 1 and 2A, the sensors overlapping at the end of the exposure windows for the first lines of each respective sensor. The signal timing diagram indicates a master reset signal 201, a master read signal 203, a synchronization signal 205, a slave reset signal 207, and a slave read signal 209. The master reset signal 201 and the master read signal 203 may be controlled internally by the master RGB sensor 116. The master reset signal 201 may indicate when the master RGB sensor 116 is reset after each master read signal 203, while the master read signal 203 may indicate when the master RGB sensor 116 (e.g., a particular line) is read out after the particular line is exposed. The synchronization signal 205 may be the signal that is communicated between the master RGB sensor 116 and the slave NIR sensor 114 to synchronize one or more of the exposure or read out of the two sensors. The slave reset signal 207 may indicate when the slave NIR sensor 114 is reset after each slave read signal 209 and the slave read signal 209 may indicate when a particular line of the slave NIR sensor 114 is read out after the particular line is exposed.

A delay 202 exists between the master read signal 203 and a subsequent synchronization signal 205, while a delay 204 exists between the synchronization signal 205 and a subsequent slave read signal 209. The delay 204 may be “fixed” in that the delay of the slave read signal 209 after receipt of the synchronization signal 205 may be programmed and/or controlled by the slave sensor, e.g., the NIR sensor 114. For example, the slave sensor may be configured internally to activate the slave read signal 209 for a current line of the slave sensor after a pre-programmed delay 204 that does not vary between lines of the slave sensor. The delay 202 may correspond to a delay of the synchronization signal 205 communicated from the master sensor (e.g., the RGB sensor 116) to the slave sensor NIR sensor 114. Accordingly, by adjusting the delay 202, the read out time of the slave NIR sensor 114 may be controlled and/or adjusted.

FIG. 2B also shows a time 206 indicating a beginning of exposure of a first line of the master RGB sensor 116. A time 208 indicates a beginning of exposure of a first line of the slave NIR sensor 114. A time 210 indicates an end of the exposures of both the first rows of the master RGB sensor 116 and the slave NIR sensor 114. The time 208 begins after the time 206 (both of which begin before the time 210) where, as here, the master RGB sensor 116 has an exposure time that is twice the exposure time of the slave NIR sensor 114 but both end exposure at the same time. A time 212 indicates an end of exposure for a last line of the slave NIR sensor 114, while a time 214 indicates an end of exposure for a last line of the master RGB sensor 116. As shown, due to the reduced number of lines for the slave NIR sensor 114, the slave NIR sensor 114 completes exposure of its last line before the master RGB sensor 116 completes exposure of its last line (e.g., time 212 before time 214), assuming both sensors have the same T_{HTS}. In static scenes, such differences between when the RGB and NIR sensors 116 and 114, respectively, end exposure of the last lines of their respective sensors, such discrepancies between the end times may not be problematic. However, in dynamic scenes, such discrepancies may create artifacts or similar issues as the two sensors may capture different scenes that cause artifacts when merged or combined.

FIG. 2C is another signal timing diagram 220 with corresponding exposure windows for the NIR sensor 114 and the RGB sensor 116 of FIGS. 1 and 2A, the sensors overlapping at the ends of the exposure windows for corresponding lines of each respective sensor. The signal timing diagram 220 indicates the same master, slave, and synchronization signals as the signal timing diagram 200 of FIG. 2B. Accordingly, these signals will not be described again here.

The delay 202 that exists between the master read signal ‘and a subsequent synchronization signal 205 may be adjusted to adjust a delay between subsequent lines of the slave NIR sensor 114. For example, the delay 202 may be increased or set at the T_{HTS} of the master RGB sensor 116, while the T_{HTS} of the slave NIR sensor 114 may be increased to be three times the T_{HTS} of the master RGB sensor 116. With such delays and adjustments, the master RGB sensor 116 and the slave NIR sensor 114 may expose corresponding sections of the scene at similar times. Since the slave NIR sensor 114 generates its reset signal based on the desired exposure time, the slave NIR sensor 114 may vary its exposure up to the master RGB sensor 116 exposure without moving the read signal for exposure of each line of the slave NIR sensor 114. Thus, the slave read signal 209 of the slave NIR sensor 114 may be delayed based on the synchronization signal 205 delayed by the delay 202 (e.g., the T_{HTS} of the master RGB sensor 116) while the slave reset signal 207 is delayed by three times the master RGB sensor T_{HTS} by increasing the T_{HTS} of the slave NIR sensor 114. In some implementations, the delay of the slave NIR sensor 114 by the T_{HTS} of the master RGB sensor 116 may synchronize the read outs of each of the lines of the sensors. The exposures of slave NIR sensor 114 may be delayed to coordinate with corresponding sections of the master RGB sensor 116 by delaying reset of the slave NIR sensor 114.

Accordingly, the times 206 and 208 (indicating the beginning of exposures of the first line of the master RGB sensor 116 and the first line of the slave NIR sensor 114, respectively) of FIG. 2C are the same as those of FIG. 2B. However, the end of exposure of the first lines of the master RGB sensor 116 and the slave NIR sensor 114 are generally aligned at times 210a and 210b, though time 210b (end of exposure of the first line of the slave NIR sensor 114) is slightly delayed in comparison with the master RGB sensor 116. The time 208 still begins after the time 206 (both of which begin before the times 210a and 210b) where, as here, the master RGB sensor 116 still has an exposure time that is approximately twice the exposure time of the slave NIR sensor 114. The time 212 indicates the end of exposure for the last line of the slave NIR sensor 114, while the time 214 indicates the end of exposure for the last line of the master RGB sensor 116. As shown, due to the delay introduced by delay 202 and by extending the T_{HTS} of the NIR sensor 114 to be three times the T_{HTS} of the RGB sensor 116, the slave NIR sensor 114 and the master RGB sensor 116 complete exposure of their respective last lines at approximately the same time.

FIG. 2D is a third signal timing diagram 240 with corresponding exposure windows for the NIR sensor 114 and the RGB sensor 116 of FIGS. 1 and 2A, the sensors overlapping at the centers of the exposure windows for corresponding lines of each respective sensor. The signal timing diagram 240 indicates the same master, slave, and synchronization signals as the signal timing diagram 200 of FIG. 2B. Accordingly, these signals will not be described again here.

The delay 202 that exists between the master read signal 203 and a subsequent synchronization signal 205 may be reduced, which may cause the exposure window of the slave NIR sensor 114 to be aligned with the master RGB sensor 116 at a center of the lines. Additionally, as discussed in relation to FIG. 2C, the T_{HTS} of the slave NIR sensor 114 may be increased to be three times the T_{HTS} of the master RGB sensor 116, which may allow the sensors to expose corresponding sections of the scene at the same time. Accordingly, the combination of the reduced delay and the increased T_{HTS} may allow for the exposure windows of the master RGB sensor 116 and the slave NIR sensor 114 to be aligned and coordinated with regard to corresponding sections of the scene.

Accordingly, the time 206 (indicating the beginning of exposure of the first line of the master RGB sensor 116) of FIG. 2C are the same as those of FIG. 2B. However, the time 208 (indicating the beginning of exposure of the first line of the slave NIR sensor 114) is advanced as compared to that of FIG. 2B, such that the centers of the exposure windows of the two sensors are aligned. Accordingly, time 210a (e.g., the end of exposure of the first line of the master RGB sensor 116) now occurs after the time 210b (e.g., the end of exposure of the first line of the slave NIR sensor 114). Additionally, the time 214 (e.g., the end of exposure of the last line of the master RGB sensor 116) begins after the time 212 (e.g., the end of exposure of the last line of the slave NIR sensor 114). As shown, due to the reduced delay (introduced by the delay 202) and by extending the T_{HTS} of the NIR sensor 114 to be three times the T_{HTS} of the RGB sensor 116, the slave NIR sensor 114 and the master RGB sensor 116 complete exposure of corresponding portions of the scene at an aligned time.

The example exposure windows shown in FIGS. 2B-2D show the master RGB sensor 116 and the slave NIR sensor 114 having similar timings (e.g., the slopes and shapes of the windows shown are similar. However, as the timings between the sensors are more different (e.g., the slopes and shapes of their exposure windows are more different), the overlap of the corresponding exposure windows may be reduced and artifacts caused by a rolling shutter effect may increase in the slave NIR sensor 114. By moving the exposure window of the slave NIR sensor 114 as described herein, exposure overlap between the master RGB sensor 116 and the slave NIR sensor may be achieved and the rolling shutter effect may be reduced. In some implementations, the slave NIR sensor 114 may have illumination that is controlled to illuminate only during a period of exposure overlap between the two sensors.

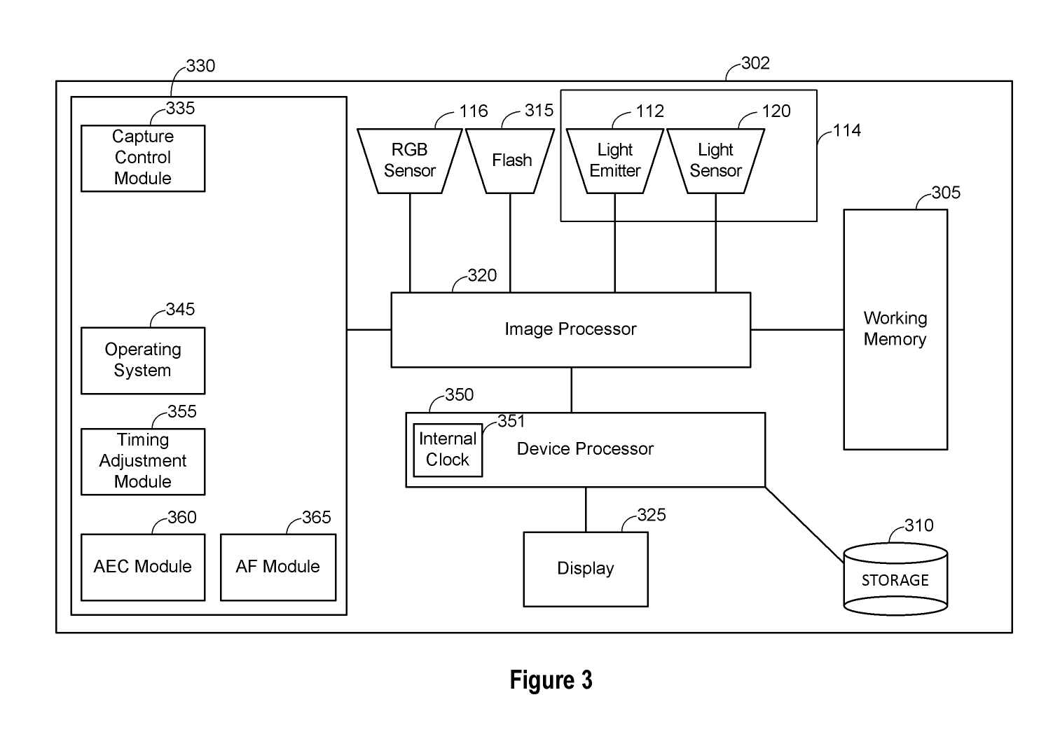

FIG. 3 is a block diagram illustrating an example of one embodiment of an image capture device 302 (e.g., camera 302) comprising asymmetric sensors, in accordance with an exemplary embodiment. The camera 302 has a set of components including an image processor 320 coupled to the RGB sensor 116 of FIG. 1, to a flash (or other light source) 315, to the NIR emitter 112 and NIR light sensor 120, and to a memory 330 that may comprise modules for determining automatic exposure or focus control (AEC module 360 and auto-focus (AF) module 365) and for controlling synchronization of the NIR sensor 114 and RGB sensor 116 (timing adjustment module 355). The camera 302 may correspond to the camera 102 of FIG. 1. Alternatively, or additionally, in some embodiments, the various components of the image capture device 302 may be directly (not shown) or indirectly coupled to each other. For example, the device processor 350 may be directly or indirectly coupled to the flash 315 and/or the memory 330 and may provide control aspects to the components to which it is coupled.

The image processor 320 may also be in communication with a working memory 305, the memory 330, and a device processor 350, which in turn may be in communication with electronic storage module 310 and a display 325 (for example an electronic or touchscreen display). In some embodiments, a single processor may comprise both the image processor 320 and the device processor 350 instead of two separate processors as illustrated in FIG. 3. In some embodiments, one or both of the image processor 320 and the device processor 350 may comprise a clock 351, shown in FIG. 3 as integrated within the device processor 350. Some embodiments may include three or more processors. In some embodiments, additional processors dedicated to the NIR sensor 114 and the RGB sensor 116 may be included. In some embodiments, some of the components described above may not be included in the camera 302 or additional components not described above may be included in the camera 302. In some embodiments, one or more of the components described above or described as being included in the camera 302 may be combined or integrated into any other component of the camera 302. In some implementations, though not shown, each sensor may be coupled to a separate image processor 320, each of which may be coupled to the device processor 350 and/or to each other and the other components of the image capture device 302.

The camera 302 may be, or may be part of, a cell phone, digital camera, tablet computer, personal digital assistant, laptop computer, personal camera, action camera, mounted camera, connected camera, wearable device, automobile, drone, or the like. The camera 302 may also be a stationary computing device or any device in which multiple asymmetric sensors are integrated. A plurality of applications may be available to the user on the camera 302. These applications may include traditional photographic and video applications, high dynamic range imaging, panoramic photo and video, or stereoscopic imaging such as 3D images or 3D video.

Still referring to FIG. 3, the camera 302 includes the RGB sensor 116 for capturing images of the target object 110 in view of ambient lighting or light from the flash 315. The camera 302 may include at least one optical imaging component (not shown) that focuses light received from the field of view (FOV) of the camera 302 to the RGB sensor 116. The AF module 365 may couple to the at least one optical imaging component. The AEC module 360 may couple to one or both of the at least one optical imaging component, the NIR sensor 114, and the RGB sensor 116. In some embodiments, the camera 302 may include more than one RGB sensor 116. In some embodiments, the RGB sensor 116 may be replaced with one or more other sensors. The RGB sensor 116 may be coupled to the image processor 320 to transmit a captured image of a field of view to the image processor 320. In this embodiment, signals to and from the RGB sensor 116 are communicated through the image processor 320.

The camera 302 may include the flash 315. In some embodiments, the camera 302 may include a plurality of flashes. The flash 315 may include, for example, a flash bulb, a reflector, a geometric light pattern generator, or an LED flash. The image processor 320 and/or the device processor 350 can be configured to receive and transmit signals from the flash 315 to control the flash output.

The image processor 320 may be further coupled to the NIR sensor 114. In some embodiments, the NIR sensor 114 may include the light emitter 112 and the NIR light sensor 120 (FIG. 1). The light emitter 112 may be configured to emit radiation (for example, NIR light) from the NIR sensor 114. For ease of description, any radiation emitted from the NIR sensor 114 will be referred to as “light.” The light is directed at the target object 110 of the camera 302. The NIR light sensor 120 is configured to sense light emitted by the light emitter 112 after the light has reflected from the target object 110. In some embodiments, the NIR light sensor 120 may be configured to sense light reflected from multiple target objects of a scene.

As illustrated in FIG. 3, the image processor 320 is connected to the memory 330 and the working memory 305. In the illustrated embodiment, the memory 330 may be configured to store one or more of the capture control module 335, the operating system 345, the timing adjustment module 355, the AEC module 360, and the AF module 365. Additional modules may be included in some embodiments, or fewer modules may be included in some embodiments. These modules may include instructions that configure the image processor 320 to perform various image processing and device management tasks. The working memory 305 may be used by the image processor 320 to store a working set of processor instructions or functions contained in one or more of the modules of the memory 330. The working memory 305 may be used by the image processor 320 to store dynamic data created during the operation of the camera 302 (e.g., one or more exposure control algorithms for one or both of the NIR sensor 114 and the RGB sensor 116, determined exposure values for one or both of the NIR sensor 114 and the RGB sensor 116, or synchronization timing adjustments). While additional modules or connections to external devices or hardware may not be shown in this figure, they may exist to provide other exposure and focus adjustment and estimation options or actions.

As mentioned above, the image processor 320 may be configured by or may be configured to operate in conjunction with the several modules stored in the memory 330. The capture control module 335 may include instructions that control the overall image capture functions of the camera 302. For example, the capture control module 335 may include instructions that configure the image processor 320 to capture raw image data of the target object 110 of FIG. 1 using one or both of the NIR sensor 114 and the RGB sensor 116. The capture control module 335 may also be configured to activate the flash 315 when capturing the raw image data. In some embodiments, the capture control module 335 may be configured to store the captured raw image data in the electronic storage module 310 or to display the captured raw image data on the display 325. In some embodiments, the capture control module 335 may direct the captured raw image data to be stored in the working memory 305. In some embodiments, the capture control module 335 may call one or more of the other modules in the memory 330, for example the AEC module 360 or the AF module 365 when preparing to capture an image of the target object. In some implementations, the capture control module may call the timing adjustment module 355 to determine and implement a delay of one of the RGB sensor 116 and the NIR sensor 114 to synchronize their operation and image capture.

The AEC module 360 may comprise instructions that allow the image processor 320, the device processor 350, or a similar component to calculate, estimate, or adjust the exposure of one or both of the NIR sensor 114 and the RGB sensor 116 and, thus, of the camera 302. For example, the AEC module 360 may be configured to independently determine the exposure values of one or both of the NIR sensor 114 and the RGB sensor 116. The AEC module 360 may include the instructions allowing for exposure estimations. Accordingly, the AEC module 360 may comprise instructions for utilizing the components of the camera 302 to identify and/or estimate exposure levels. Additionally, the AEC module 360 may include instructions for performing local automatic exposure control for each of the NIR sensor 114 and the RGB sensor 116. In some embodiments, each of the NIR sensor 114 and the RGB sensor 116 may comprise individual AEC modules (not shown). In some embodiments, the AEC module or modules 360 may determine the exposure value for the associated sensor or sensors. The exposure values may be fed or programmed into the sensors for the next frame. In some embodiments, the AEC module or modules 360 may determine exposure values for the NIR sensor 114 and the RGB sensor 116 within a maximum exposure time limit that is set by the timing adjustment module 355. The determined exposure values may also be communicated to the timing adjustment module 355 via one or more of the image processor 320, the device processor 350, or another processor. In some embodiments, the AEC module 360 may be configured to identify an exposure value of the associated sensor or sensors for a subsequent frame. In some embodiments, the AEC module 360 may further comprise instructions for synchronizing the NIR sensor 114 and the RGB sensor 116 at one or more identified or estimated exposure levels.

The timing adjustment module 355 may utilize exposure information received from the AEC module 360 to advance or delay synchronization signals between the NIR sensor 114 and the RGB sensor 116 based on one of the NIR sensor 114 and the RGB sensor 116 being identified as the “master” and the other being identified as the “slave.” For purposes of this description, the RGB sensor 116 will be designated as the master and the NIR sensor 114 will be the slave, though any other combination of master and slave is permissible. The synchronization signals between the NIR sensor 114 and the RGB sensor 116 may be utilized to synchronize exposure windows of each of the NIR sensor 114 and the RGB sensor 116. The exposure windows may correspond to windows of time during which each line of each of the NIR sensor 114 and the RGB sensor 116 is exposed, non-inclusive of any delays or readout durations. The exposure windows may include the time from when the first row of each sensor is initially exposed to the time when the last row of each sensor is exposed.

The timing adjustment module 355 may respond to each of three different scenarios in a two-sensor system and calculate a delay needed to align the line exposure (and corresponding readout) of the RGB sensor 116 and the NIR sensor 114. In some embodiments, the timing adjustment module 355 may also update and/or calculate maximum allowable frame rates for one or both of the RGB sensor 116 and the NIR sensor 114. In some embodiments, the updating or calculating of maximum allowable frame rates may be performed by a frame rate module (not shown). In some embodiments, the delay and frame rate calculations may be made based on the exposure values of the RGB sensor 116 and the NIR sensor 114.

When the camera 302 includes two sensors (e.g., the NIR sensor 114 and the RGB sensor 116), the three scenarios of exposure values between the two sensors may include: the NIR sensor 114 and the RGB sensor 116 having the same exposure levels, the NIR sensor 114 having a greater exposure level than the RGB sensor 116, or the NIR sensor 114 having a lesser exposure level than the RGB sensor 116. The exposure levels may correspond to an amount of time required for proper exposure. Accordingly, a greater exposure level corresponds to a longer period of time needed to properly expose a pixel line of the respective sensor. According to these scenarios, the delay value used to delay the synchronization signals between the master and the slave sensors may be determined. Additionally, the timing adjustment module 355 may determine the delay value based on when the NIR sensor 114 and the RGB sensor 116 are desired to overlap (e.g., at the beginning portion of the line, middle portion of the line, or end portion of the line, as described herein).

When the exposure levels are the same between the two sensors, the delay value for synchronizing the line exposure and readout between the two sensors may be a set delay value. This delay value may not need to be adjusted because the exposure windows of the two sensors may overlap. However, as the exposure level of the slave sensor changes to more or less than the exposure level of the master exposure, the delay value may be moved forward or backward (as described herein). When the slave NIR sensor 114 has a smaller or shorter exposure level than the master RGB sensor 116 and is to be synchronized to end exposure of the first line with the end of exposure of the first line of the master RGB sensor 116, the timing adjustment module may set the delay value to delay the exposure of each line of the NIR sensor 116, thereby delaying the synchronization signal communicated from the master RGB sensor 116 to the slave NIR sensor 114. By delaying the synchronization signal, the readout of the NIR sensor 114 may be delayed, as there may be a fixed delay between when the synchronization signal is received from the master RGB sensor 116 and when the readout of the NIR sensor 114 occurs. The delay duration may be determined based on one or more of the exposure value difference between the master RGB sensor 116 and the slave NIR sensor 114 and any other differences between the sensors (e.g., pixel size, physical size, etc.). The synchronization signal may be delayed when the NIR sensor 114 has a greater exposure level than the RGB sensor 116. For example, the timing adjustment module 355 may set the delay value to advance the exposure of the NIR sensor 114, thereby advancing the synchronization signal.

Still referring to FIG. 3, the operating system 345 may configure the image processor 320 to manage the working memory 305 and the processing resources of camera 302. For example, the operating system 345 may include device drivers to manage hardware resources such as the NIR sensor 114, the RGB sensor 116, the flash 315, and the various memory, processors, and modules. Therefore, in some embodiments, instructions contained in the processing modules discussed above and below may not interact with these hardware resources directly, but instead interact with this hardware through standard subroutines or APIs located in the operating system 345. Instructions within the operating system 345 may then interact directly with these hardware components. The operating system 345 may further configure the image processor 320 to share information with device processor 350. The operating system 345 may also include instructions allowing for the sharing of information and resources between the various processing modules of the image capture device. In some embodiments, the processing modules may be hardware themselves.

The AF module 365 can include instructions that configure the image processor 320 to adjust the focus position of the one or more optical imaging components of the RGB sensor 116. The AF module 365 can include instructions that configure the image processor 320 to perform focus analyses and automatically determine focus parameters in some embodiments, and can include instructions that configure the image processor 320 to respond to user-input focus commands in some embodiments. In some embodiments, the AF module 365 may include instructions for identifying and adjusting the focus of the optical imaging components based on light emitted from the flash 315. In some embodiments, the AF module 365 may be configured to receive a command from the capture control module 335, the AEC module 360, or from one of the image processor 320 or device processor 350.

In FIG. 3, the device processor 350 may be configured to control the display 325 to display the captured image, or a preview of the captured image including estimated exposure and focus settings, to a user. The display 325 may be external to the camera 302 or may be part of the camera 302. The display 325 may also be configured to provide a viewfinder displaying the preview image for the user prior to capturing the image of the target object, or may be configured to display a captured image stored in the working memory 305 or the electronic storage module 310 or recently captured by the user. The display 325 may include a panel display, for example, a LCD screen, LED screen, or other display technologies, and may implement touch sensitive technologies. The device processor 350 may also be configured to receive an input from the user. For example, the display 325 may also be configured to be a touchscreen, and thus may be configured to receive an input from the user. The user may use the display 325 to input information that the device processor 350 may provide to the AEC module 360 or the AF module 365. For example, the user may use the touchscreen to select the target object from the FOV shown on the display 325 or set or establish the exposure levels and focus settings of the camera 302. The device processor 350 may receive that input and provide it to the appropriate module, which may use the input to select perform instructions enclosed therein (for example, determine the focus of the target image at the AF module 365, etc.).

In some embodiments, the device processor 350 may be configured to control the one or more of the processing modules in the memory 330 or to receive inputs from one or more of the processing modules in the memory 330.

The device processor 350 may write data to the electronic storage module 310, for example data representing captured images. While the electronic storage module 310 is represented graphically as a traditional disk device, in some embodiments, the electronic storage module 310 may be configured as any storage media device. For example, the electronic storage module 310 may include a disk drive, such as a floppy disk drive, hard disk drive, optical disk drive or magneto-optical disk drive, or a solid-state memory such as a FLASH memory, RAM, ROM, and/or EEPROM. The electronic storage module 310 can also include multiple memory units, and any one of the memory units may be configured to be within the camera 302, or may be external to the camera 302. For example, the electronic storage module 310 may include a ROM memory containing system program instructions stored within the camera 302. The electronic storage module 310 may also include memory cards or high speed memories configured to store captured images which may be removable from the camera.

Although FIG. 3 depicts a image capture device 302 having separate components to include a processor, imaging sensor, and memory, in some embodiments these separate components may be combined in a variety of ways to achieve particular design objectives. For example, in an alternative embodiment, the memory components may be combined with processor components to save cost and improve performance.

Additionally, although FIG. 3 illustrates a number of memory components, including the memory 330 comprising several processing modules and a separate memory comprising a working memory 305, in some embodiments, different memory architectures may be utilized. For example, a design may utilize ROM or static RAM memory for the storage of processor instructions implementing the modules contained in memory 330. The processor instructions may be loaded into RAM to facilitate execution by the image processor 320. For example, working memory 305 may comprise RAM memory, with instructions loaded into working memory 305 before execution by the image processor 320. In some embodiments, one or more of the processing modules may be software stored in the memory 330 or may comprise a hardware system combined with the software components. Furthermore, functions associated above with one of the image processor 320 and the device processor 350 may be performed by the other of the image processor 320 and the device processor 350 or both the image processor 320 and the device processor 350, though not described as such above.

In some embodiments, the image processor 320 may be further configured to participate in one or more processing operations prior to capturing an image, while capturing an image, and after capturing an image. For example, prior to capturing the image, the image processor 320 may be configured to perform one or more of the processes described above (e.g., estimating and adjusting the exposure and the focus of the camera 302). In some embodiments, the image processor 320 may be configured to, in conjunction with one or more of the flash 315, the timing adjustment module 355, the AEC module 360, and the AF module 365, adjust the exposure and the synchronization of the NIR sensor 114 and the RGB sensor 116. The image processor 320 may thus be configured to enable the camera 302 to capture an image of the target object or FOV with proper settings (exposure and focus) as desired by the user.

In some embodiments, the image processor 320 may be involved with and/or control the adjustment and estimation of the exposure and synchronization of the NIR sensor 114 and the RGB sensor 116. For example, the image processor 320 may receive the delay values from the timing adjustment module 355 and cause the delay or advancement of one or both of the NIR sensor 114 and the RGB sensor 116.

Alternatively, or additionally, the image processor 320 may only act in response to instructions from one or more other components or modules of the camera 302. For example, the timing adjustment module 355, the AEC module 160, or the AF module 165 may issue instructions to other components of the camera 302 to allow the timing adjustment module 355 to determine and implement the delay for one of the NIR sensor 114 and the RGB sensor 116, to allow the AEC module 360 to calculate exposure values for the NIR sensor 114 and the RGB sensor 116 as described above, or to allow the AF module 365 to calculate the estimated focus as described above. Additionally, statistics may be collected using various hardware (such as an image signal processor (ISP)) based on the image data from the sensor at real time. For example, the collected statistics may be sums and averages of all regions on a certain size grid, such as 64×48. The collected statistics may also include histograms of the image data.

Many image capture devices (e.g., cameras and camcorders, etc.) utilize electronic rolling shutter image capture methods. Rolling shutter methods capture a frame of the FOV by scanning across the scene rapidly, either vertically or horizontally, over a brief period of time. Accordingly, not all parts of the image of the scene are captured at exactly the same instant, meaning that distortions may be generated when a portion of the FOV or target is in motion.

In the electronic rolling shutter capture methods, exposure of each line or row of pixels of the sensor begins and ends at different times. Each line or row has its own reset and read signals that are generated by the sensor control system (e.g., the capture control module 335 or the operating system 345 described above in reference to FIG. 3). Once a sensor starts being exposed and read out, the read signal preserves sensor timing. However, the reset signal may be moved forward and backward in relation to the readout signal to control exposure times of each line. Once exposure of a first row starts, exposure of the immediately subsequent row may start after a time T_{HTS} passes. The time T_{HTS} may correspond to a total time that it takes for each row to be sampled, converted, and transmitted (e.g., read out) from the sensor plus an additional horizontal blanking period. Accordingly, each row is delayed by the time T_{HTS} so that data for each line is transmitted to the host every horizontal line period.

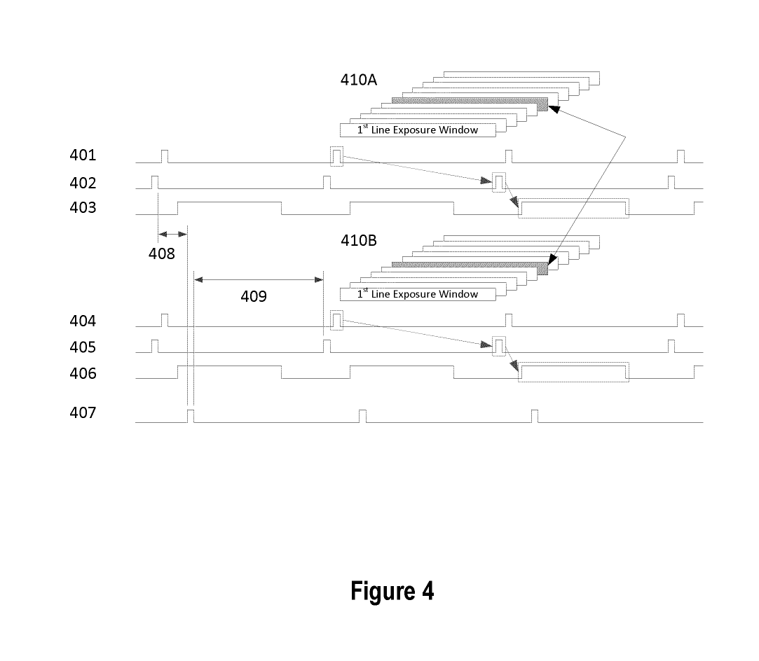

FIG. 4 illustrates an example of an exposure and synchronization timing diagram 400 of an image capture device comprising symmetric sensors, in accordance with some embodiments. The timing diagram 400 shows an example of traditional synchronization in the image capture device comprising the symmetric sensors. For example, the symmetric sensors may comprise a master RGB sensor and a slave RGB sensor. The exposure levels of each of the master and slave RGB sensors are shown as 410A and 410B, respectively. As shown, the exposure levels of the maters and slave RGB sensors may be identical.

Lines 401 and 404 of the timing diagram 400 correspond to the master and slave sensor exposure reset signals, respectively. These signals correspond to times when the master and slave sensor exposure levels are reset (e.g., when the signal is high, the exposure levels are reset). Lines 402 and 405 of the timing diagram 400 correspond to the master and slave sensor read signals, respectively. Raising edges of these signals correspond to the start of the master and slave sensor values read out by the analog to digital converter. Lines 403 and 406 of the timing diagram 400 correspond to the master and slave sensor frame valid signals, respectively. These signals correspond to frame periods of the master and slave sensor. Line 407 corresponds to the master/slave synchronization signal, which corresponds to the signal to which the read signal of the slave sensor is based on to ensure synchronization with the master sensor. The delay period 408 corresponds to a delay between the read signal of the master sensor and the master/slave synchronization signal. The delay period 409 corresponds to a delay between the master/slave synchronization signal and the read signal of the slave sensor. The delay period 409 may represent the delay that synchronizes the overlap of the master and slave sensor exposures. The combination of the delay periods 408 and 409 provide for the synchronization of the read signals of the master and slave sensors.

Based on the delay periods 408 and 409 and the synchronization signals, exposures of each line for all frames N+1 (where frame N is the first frame where exposure levels are determined) are synchronized. As shown in FIG. 4, the reset signals of lines 401 and 404 move with the read signals of lines 402 and 405, thus keeping the frames synchronized. Accordingly, the frames are kept in sync by exposing corresponding lines of the frames at similar times.

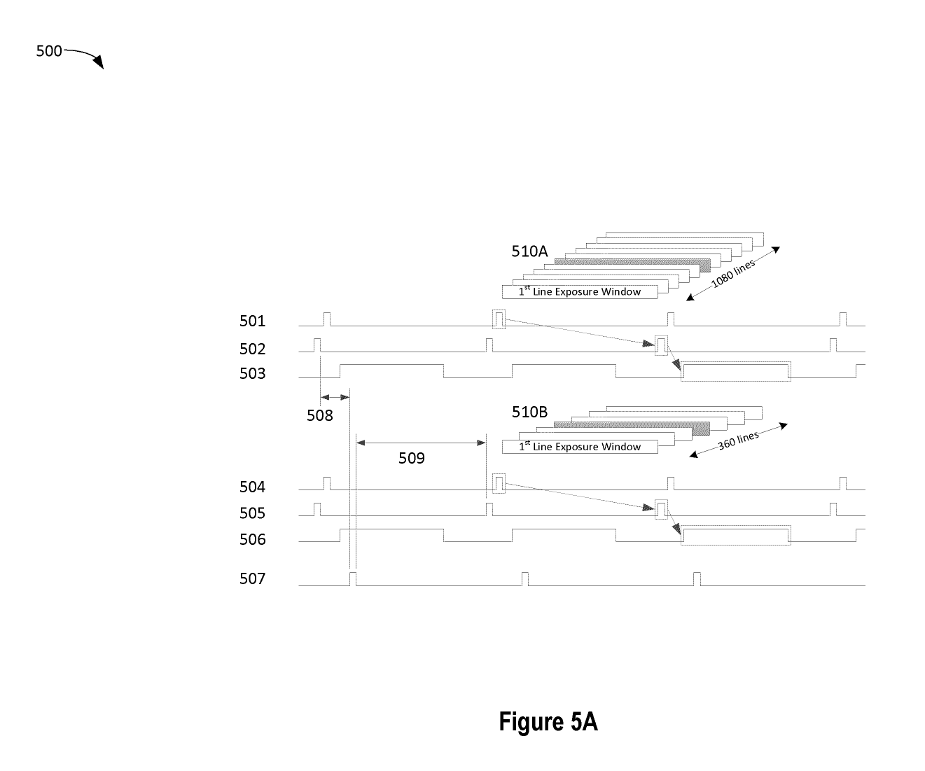

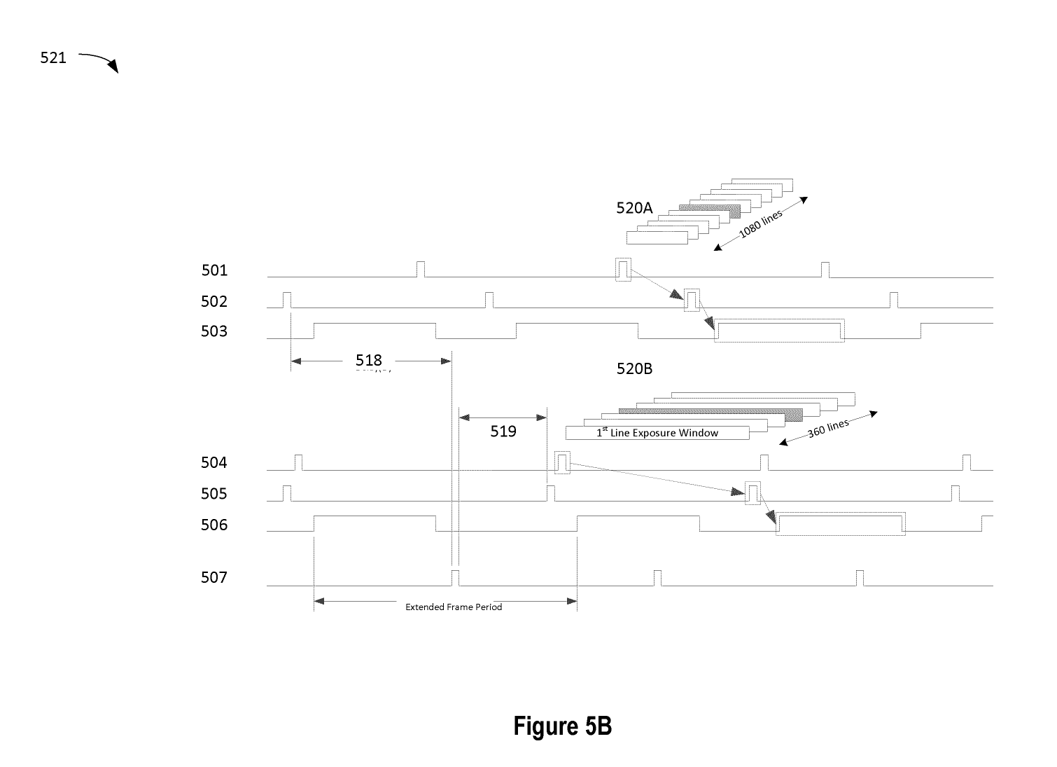

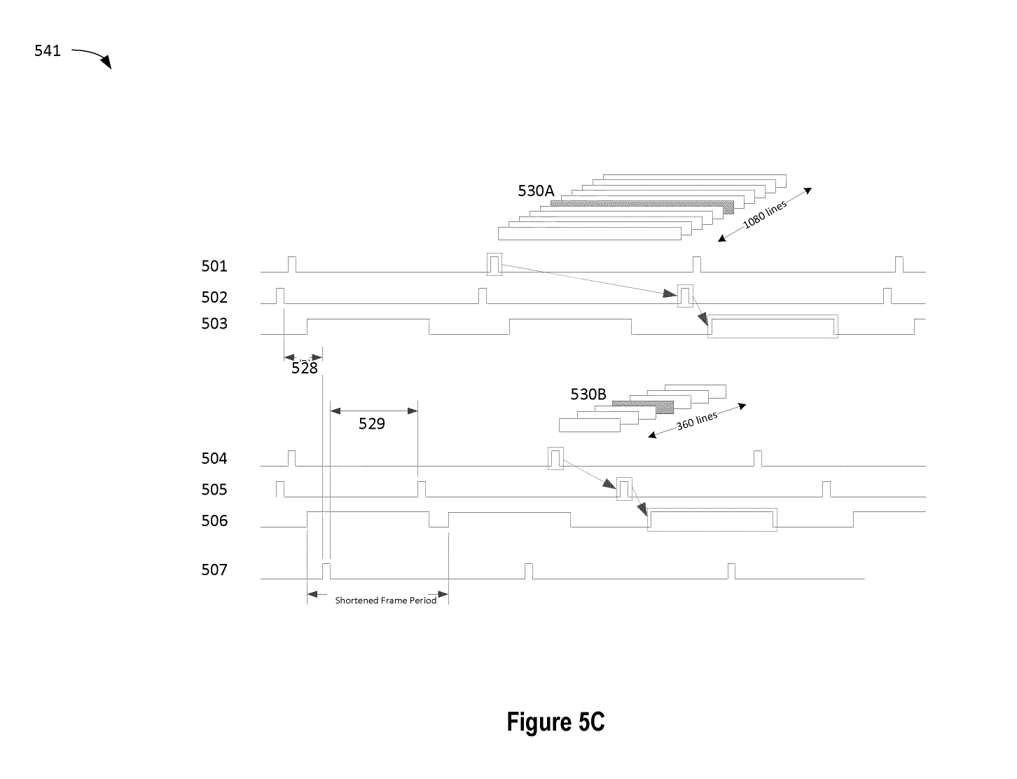

FIG. 5A illustrates an example of an exposure and synchronization timing diagram 500 of the image capture device 102 of FIG. 1 where the exposures of the asymmetric NIR and RGB sensors 114 and 116, respectively, are equal, in accordance with an exemplary embodiment. The timing diagram 500 shows an example of exposure synchronization in the image capture device 102 comprising asymmetric sensors (e.g., RGB sensor 116 and NIR sensor 114). For example, the asymmetric sensors may comprise a master RGB sensor 116 and a slave NIR sensor 114. The exposure levels of each of the master and slave sensors (e.g., the master RGB sensor 116 and the slave NIR sensor 114) are shown as 510A and 510B, respectively.

A master sensor exposure reset signal 501 and a slave sensor exposure reset signal 504 are shown. These signals correspond to times when the master and slave sensors are reset after sensor exposure and read out (e.g., when the signal is high, the exposure levels are reset). As described herein, delay of the reset signals 501 and 504 may cause the corresponding exposure windows to be delayed. In addition to the master and slave sensor reset signals 501 and 504, respectively, master and slave sensor read signals 502 and 505, respectively, are shown. These signals correspond to times when the master and slave sensors are read out to the image processor after exposure (e.g., raising edge of the signals indicate the beginning of the sensors' read out). The timing diagram 500 further includes master and slave sensor frame period signals 503 and 506, respectively. These signals correspond to frame periods of the master and slave sensors. A master/slave synchronization signal 507 corresponds to the signal to which the read signal 505 of the slave sensor is based on to ensure synchronization of the slave sensor with the master sensor. The delay period 508 corresponds to a delay between the read signal 502 of the master sensor and the master/slave synchronization signal 507. The delay period 509 corresponds to a delay between the master/slave synchronization signal 507 and the read signal 505 of the slave sensor. As described herein, the delay period 508 may represent the delay that synchronizes the overlap of the master and slave sensor exposures. The combination of the delay periods 508 and 509 provide for the synchronization of the read signals 502 and 505, respectively, of the master and slave sensors.

Based on the delay periods 508 and 509 and the synchronization signal 507, exposures of each line for all frames N+1 (where frame N is the first frame where exposure levels are determined) are synchronized. As shown in FIG. 5, the reset signals 501 and 504 move with the read signals 502 and 505, respectively, thus keeping the exposure windows of the lines synchronized.

As shown, when the exposure windows are the same duration for both the master and slave sensors, we see that the timing diagram 500 of FIG. 5A matches the timing diagram 400 of FIG. 4.

FIG. 5B illustrates an example of an exposure and synchronization timing diagram 521 of the image capture device 102 of FIG. 1, where an exposure level of the NIR sensor 114 is greater than an exposure level of the RGB sensor 116, in accordance with an exemplary embodiment. The timing diagram 521 shows an example of exposure synchronization in the image capture device 102 comprising asymmetric sensors (e.g., RGB sensor 116 and NIR sensor 114). For example, the asymmetric sensors may comprise a master RGB sensor 116 and a slave NIR sensor 114. The exposure levels of each of the master and slave sensors are shown as 520A and 520B, respectively.

The timing diagram 521 shows master and slave sensor exposure reset signals 501 and 504, respectively, master and slave sensor read signals 502 and 505, respectively, master and slave sensor frame period signals 503 and 506, respectively, and a master/slave synchronization signal 507, similar to those of FIG. 5A. Accordingly, these signals will not be described again here. The delay period 518 corresponds to a delay between the read signal 502 of the master sensor and the master/slave synchronization signal 507. The delay period 519 corresponds to a delay between the master/slave synchronization signal 507 and the read signal 505 of the slave sensor. The delay period 518 may represent the delay that synchronizes the overlap of the master and slave sensor exposures. The combination of the delay periods 518 and 519 provide for the synchronization of the read signals 502 and 505 of the master and slave sensors, respectively.

Based on the delay periods 518 and 519 and the synchronization signal 507, exposures of each line for all frames N+1 (where frame N is the first frame where exposure levels are determined) are synchronized. As described herein, the reset signals 501 and 504 move with the read signals 502 and 505 of lines, thus keeping the frames synchronized.

FIG. 5C illustrates an example of an exposure and synchronization timing diagram 541 of the image capture device 102 of FIG. 1, where an exposure level of the NIR sensor 114 is less than an exposure level of the RGB sensor 116, in accordance with an exemplary embodiment. The timing diagram 541 shows an example of exposure synchronization in the image capture device 102 comprising asymmetric sensors (e.g., RGB sensor 116 and NIR sensor 114). For example, the asymmetric sensors may comprise a master RGB sensor 116 and a slave NIR sensor 114. The exposure windows of each of the master and slave sensors are shown as 530A and 530B, respectively. As shown, the exposure windows of the master RGB sensor 116 may be longer than the exposure windows of the slave NIR sensor 114 and of different quantity (e.g., exposure windows 530A of the master RGB sensor 116 include seven (7) exposure windows while the exposure windows 531B of the slave NIR sensor 114 include eleven (11) exposure windows).

The timing diagram 541 shows master and slave sensor exposure reset signals 501 and 504, respectively, master and slave sensor read signals 502 and 505, respectively, master and slave sensor frame period signals 503 and 506, respectively, and a master/slave synchronization signal 507, similar to those of FIG. 5A. These signals will not be described again here. The delay period 528 corresponds to a delay between the read signal 502 of the master sensor and the master/slave synchronization signal 507. The delay period 529 corresponds to a delay between the master/slave synchronization signal 507 and the read signal 505 of the slave sensor. The delay period 528 may represent the delay that synchronizes the overlap of the master and slave sensor exposures. The combination of the delay periods 528 and 529 provide for the synchronization of the read signals 502 and 505 of the master and slave sensors, respectively.

Based on the delay periods 528 and 529 and the synchronization signal 507, exposures of each line for all frames N+1 (where frame N is the first frame where exposure levels are determined) are synchronized. As shown in FIG. 5C, the reset signals 501 and 504 of lines move with the read signals 502 and 505, thus keeping the frames synchronized.

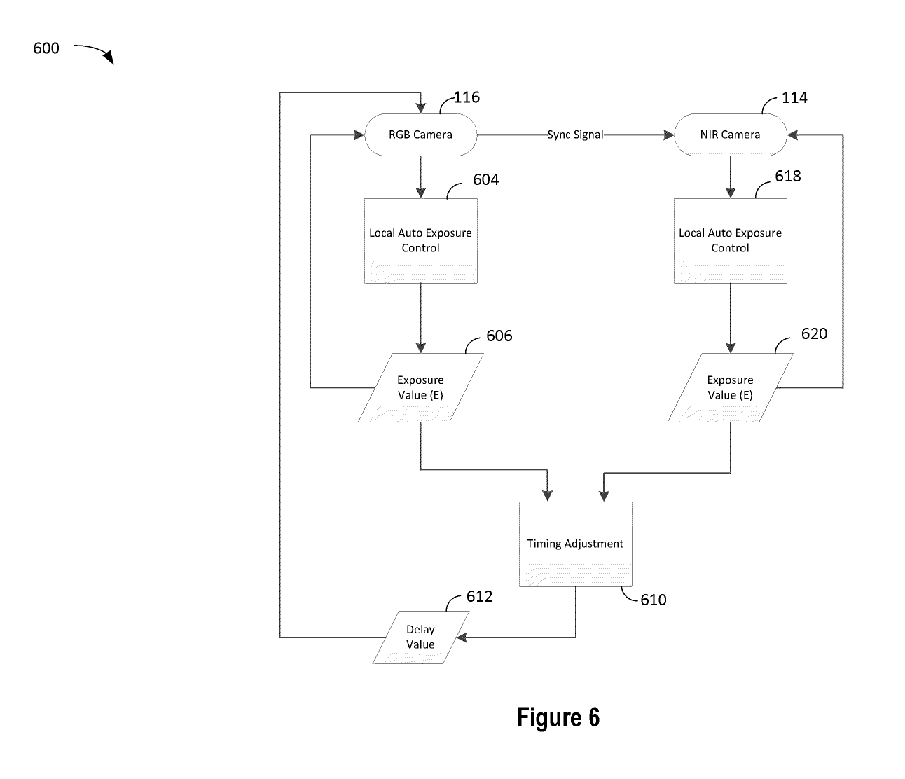

FIG. 6 is a structure and data flow diagram 600 indicating an exposure and timing control of the asymmetric sensors of the image capture device 102 of FIG. 1, according to an exemplary embodiment. This exposure timing and control may be performed for each frame being captured by the NIR sensor 114 and the RGB sensor 116 (FIG. 1). In some implementations, one or more steps of the exposure and timing control may be performed by one or more modules and/or components of the camera 302. For example, one or more of the RGB sensor 116, the NIR sensor 114, the AEC module 360, the timing adjustment module 355, the image processor 320, or the operating system module 345 may perform one or more of the steps of the flow diagram 600. The flow diagram 600 may be repeated for each frame being captured by the camera 102 until all of the frames of the target image are captured.

The flow diagram 600 includes the RGB sensor 116 and the NIR sensor 114. The RGB sensor 116 and the NIR sensor 114 may each have dedicated flows in parallel. For example, the RGB sensor 116, or corresponding dedicated components, may perform local exposure control and exposure determination in parallel with and independent of the NIR sensor 114, or corresponding dedicated components, performing local exposure control and exposure determination. In some embodiments, different components may be used by each of the RGB sensor 116 and the NIR sensor 114 to perform the respective steps.

Blocks 604 and 618 may correspond to local automatic exposure control for the RGB sensor 116 and the NIR sensor 114, respectively. In some embodiments, the local automatic exposure control 604 and 618 may be performed independently and individually by one or more modules or processors that are dedicated to each respective sensor. In some implementations, the local automatic exposure control 604 and 618 may be performed independently by one or more modules or processors that performs the local automatic exposure control for both of the RGB sensor 116 and the NIR sensor 114. For example, the local automatic exposure control 604 and 618 may be performed by the AEC module 360 or a similar module. The local automatic exposure control 604 and 618 may generate or determine the exposure level (e.g., time) that is needed for the respective sensor to be properly exposed for the frame being captured by the RGB sensor 116 and the NIR sensor 114.

Blocks 606 and 620 may correspond to the exposure values as generated by the local automatic exposure control blocks 604 and 618, respectively, being communicated to the timing adjustment module 355 and to the RGB sensor 116 and the NIR sensor 114, respectively. Accordingly, in some embodiments, the exposure values are provided to the image processor 320 or device processor 350 or fed back to the RGB sensor 116 and the NIR sensor 114 for programming of the RGB sensor 116 and the NIR sensor 114 for future line processing. In some embodiments, the exposure values are provided to the timing adjustment module 355 or the image processor 320 or the device processor 350 or some similar component in the camera 302. Thus, the timing adjustment module 355 or similar component may receive an exposure value E_{RGB} corresponding to the exposure level of the RGB sensor 116 and an exposure value E_{NIR} corresponding to the exposure level of the NIR sensor 114.

At block 610, the timing adjustment module 355 or similar component may receive the exposure values E_{RGB} and E_{NIR} and compare the exposure values. According to this comparison, the timing adjustment module 355 may generate a delay value 612 that is communicated to the master sensor (e.g., the RGB sensor 116) for implementation with the next frame read.

In some embodiments, the time adjustment module 355 may adjust the delay value according to Table 2. In some embodiments, a delay may inherently exist between the master and slave sensors, regardless of any details of the sensors themselves. This delay may be attributable to various parameters of the sensors as well as the circuit(s) comprising the sensors. Accordingly, this delay may be a set value. However, this set value delay may be adjusted (e.g., delayed or advanced) based on the exposure values of the master and slave sensors, as shown in Table 2 and described herein.

TABLE 2

| | Delay Values (assuming overlap |
|---|---|
| Exposures | at center of line) |
| E_{RGB} = E_{NIR} | Delay value is a set value is not adjusted |
| E_{RGB} > E_{NIR} | Delay value is adjusted (e.g., delayed) to |
| | delay the NIR sensor exposure |
| E_{RGB} < E_{NIR} | Delay value is adjusted (e.g., advanced) |
| | to advance the NIR sensor exposure |

In addition to generating the delay value based on the RGB sensor and NIR sensor exposure values, the timing adjustment module 355 or similar component may calculate and set maximum frame rates for the RGB and NIR sensors 116 and 114, respectively, based on the RGB sensor and NIR sensor exposure values and lighting conditions of the target object 110 (FIG. 1) and distance between the NIR sensor 116 and the target object 110. Table 3 below details the maximum frame rate calculations for each of the RGB sensor 116 and the NIR sensor 114.

TABLE 3

| | Lighting | | |
|---|---|---|---|
| Distance | Condition | Exposures | Frame Rates |
| Close | Good | E_{RGB} = E_{NIR} | Maximum frame rates for both |
| | | | sensors are the same. |
| Close | Poor | E_{RGB} > E_{NIR} | NIR sensor frame rate does not |
| | | | exceed maximum RGB sensor |
| | | | frame rate. |
| Far | Good | E_{RGB} < E_{NIR} | RGB sensor frame rate does not |
| | | | exceed maximum NIR sensor |
| | | | frame rate. |
| Far | Poor | E_{RGB} = E_{NIR} | Maximum frame rates for both |
| | | | sensors are the same. |

As detailed in Table 3, when the exposure levels of the RGB sensor 116 and the NIR sensor 114 are equal (for example, when both the distance between the NIR sensor 114 and the target object 110 is small and the target object is well lit), the maximum frame rates for both sensors are the same. When the exposure level of the RGB sensor 116 is greater than the exposure level of the NIR sensor 114 (for example, when the distance between the target object 110 is small and the target object is poorly lit), the maximum frame rate for both sensors is set at the maximum frame rate for the RGB sensor 116. This is because the RGB sensor frame rate is controlling because the RGB sensor 116 requires more time to reach the exposure level and the NIR sensor 114 is synchronized to the RGB sensor 116. When the exposure level of the NIR sensor 114 is greater than the exposure level of the RGB sensor 116 (for example, when the distance between the target object 110 is large and the target object is well lit), the maximum frame rate for both sensors is set at the maximum frame rate for the NIR sensor 114. This is because the NIR sensor frame rate is controlling because the NIR sensor 114 requires more time to reach the exposure level and the NIR sensor 114 is synchronized to the RGB sensor 116. Accordingly, the maximum frame rate of the RGB sensor 116 and the NIR sensor 114 may be inversely proportional to the larger of the exposure level E_{RGB} and/or E_{NIR}.

Once the timing adjustment module 355 generates the delay value 612, the delay value 612 may be communicated to the master sensor (e.g., the RGB sensor 116). The RGB sensor 116 may then use the delay value to delay or advance the synchronization signal to the NIR sensor 114. In some embodiments, the delay value may be measured in line time or seconds or any other unit of time measure.

After the RGB sensor 116 communicates the synchronization signal to the NIR sensor 114, the two asymmetric sensor exposures are aligned at the center of the exposure window for the line. In some implementations, based on the delay period 409/509/519/529 of FIGS. 4-5C, respectively, the exposures of the RGB sensor 116 and NIR sensor 114 may be aligned at one of the beginning, middle, or end of the exposure window (e.g., the overlap as described above). Based on the continuous and repetitive nature of the flow diagram 600 indicating an exposure and timing control of the asymmetric sensors of the image capture device 102, this alignment and synchronization may be maintained throughout the processing of consecutive lines, frames, and images while the individual sensors are able to adapt to changes in conditions that affect their exposure. For example, the alignment and synchronization may be maintained while active sensing power control of the NIR sensor 114 adapts to changes in distance between the NIR sensor 114 and the target object 110 and/or NIR reflectance from the target object 110. Additionally, the alignment and synchronization may be maintained throughout the processing of consecutive frames regardless of changes in the lighting or illumination of the target object 110 for the RGB sensor 116.

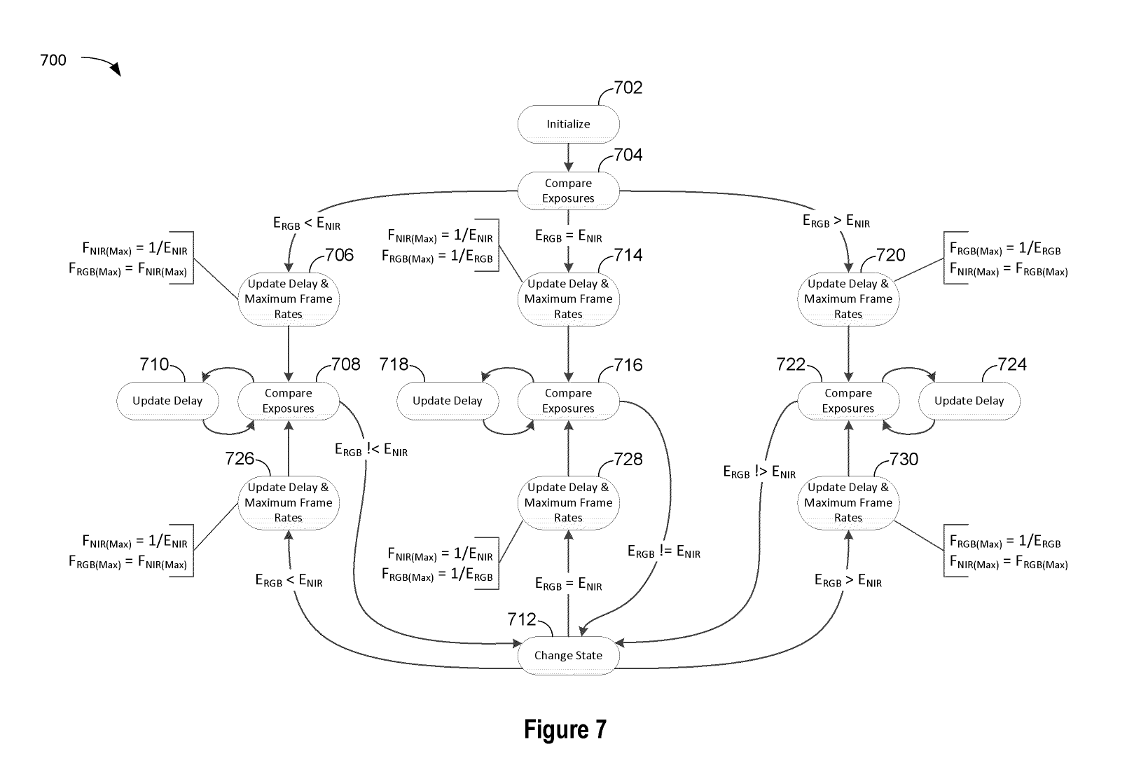

FIG. 7 is a process flow diagram of timing adjustment process 700 illustrating timing adjustment in the asymmetric sensors of the image capture device 102 of FIG. 1, according to an exemplary embodiment. This timing adjustment may be run for each frame being captured by the NIR sensor 114 and the RGB sensor 116 (FIG. 1). In some implementations, one or more blocks of the process 700 may be performed by one or more modules and/or components of the camera 302. For example, one or more of the RGB sensor 116, the NIR sensor 114, the AEC module 360, the timing adjustment module 355, the image processor 320, or the operating system module 345 may perform one or more of the blocks of the process 700. The process 700 may be repeated for each frame being captured by the camera 102 until all of the frames of the target image are captured.

The process 700 may be initialized at block 702. At block 702, the process is initialized. Once initialized, the process proceeds to block 704, where the exposures of the RGB sensor 116 and the NIR sensor 114 are compared. Based on this comparison, the process proceeds to either block 706, 714, or 720. If the exposure of the RGB sensor 116 at block 704 is less than the exposure of the NIR sensor 114, then the process 700 proceeds to block 706. If the exposure of the RGB sensor 116 at block 704 is equal to the exposure of the NIR sensor 114, then the process 700 proceeds to block 714. If the exposure of the RGB sensor 116 at block 704 is greater than the exposure of the NIR sensor 114, then the process proceeds to block 720.

At block 706, the delay values and the maximum frame rates are updated based on the compared exposures. For example, the maximum frame rate for the NIR sensor 114 is established based on the exposure of the NIR sensor 114. Specifically, the maximum frame rate of the NIR sensor 114 is the inverse of the exposure of the NIR sensor 114. Furthermore, since the exposure time of the NIR sensor 114 is greater than the exposure time of the RGB sensor 116, the exposure time of the NIR sensor 114 (and thus the maximum frame rate of the NIR sensor 114) also applies to the RGB sensor 116. Accordingly, the maximum frame rate of the RGB sensor 116 is set to the maximum frame rate of the NIR sensor 114.

Once the delays and the maximum frame rates are updated at block 706, the process proceeds to block 708. At block 708, the exposures of the NIR sensor 114 and the RGB sensor 116 may be again compared. If the exposure of the NIR sensor 114 is no longer greater than the exposure of the RGB sensor 116, then the process proceeds to block 712. If the exposure of the NIR sensor 114 is still greater than the exposure of the RGB sensor 116, then the process remains at block 708 and updates the delay and/or the maximum frame rate as needed at block 710 (e.g., if one of the exposure of the RGB sensor 116 and the NIR sensor 114 has changed).

At block 714, the delay values and the maximum frame rates are updated based on the compared exposures. For example, the maximum frame rate for the NIR sensor 114 is established based on the exposure of the NIR sensor 114. Specifically, the maximum frame rate of the NIR sensor 114 is the inverse of the exposure of the NIR sensor 114. Furthermore, the maximum frame rate for the RGB sensor 116 is established based on the exposure of the RGB sensor 116. Specifically, the maximum frame rate of the RGB sensor 116 is the inverse of the exposure of the RGB sensor 116. Accordingly, the maximum frame rate of the RGB sensor 116 is set to the maximum frame rate of the NIR sensor 114.

Once the delays and the maximum frame rates are updated at block 714, the process proceeds to block 716. At block 716, the exposures of the NIR sensor 114 and the RGB sensor 116 may be again compared. If the exposure of the NIR sensor 114 is no longer equal to the exposure of the RGB sensor 116, then the process proceeds to block 712. If the exposure of the NIR sensor 114 is still equal to the exposure of the RGB sensor 116, then the process remains at block 716 and updates the delay, as the delay may change any time either of the RGB sensor 116 exposure or the NIR sensor 114 exposure change, even if the change is not significant enough to require a change in state.

At block 720, the delay values and the maximum frame rates are updated based on the compared exposures. For example, the maximum frame rate for the RGB sensor 116 is established based on the exposure of the RGB sensor 116. Specifically, the maximum frame rate of the RGB sensor 116 is the inverse of the exposure of the RGB sensor 116. Furthermore, since the exposure time of the RGB sensor 116 is greater than the exposure time of the NIR sensor 114, the exposure time of the RGB sensor 116 (and thus the maximum frame rate of the RGB sensor 116) also applies to the NIR sensor 114. Accordingly, the maximum frame rate of the NIR sensor 114 is set to the maximum frame rate of the RGB sensor 116.

Once the delays and the maximum frame rates are updated at block 720, the process proceeds to block 722. At block 722, the exposures of the NIR sensor 114 and the RGB sensor 116 may be again compared. If the exposure of the RGB sensor 116 is no longer greater than the exposure of the NIR sensor 114, then the process proceeds to block 712. If the exposure of the RGB sensor 116 is still greater than the exposure of the NIR sensor 114, then the process remains at block 722 and updates the delay and/or the maximum frame rate as needed at block 724 (e.g., if one of the exposure of the RGB sensor 116 and the NIR sensor 114 has changed).

At block 712, the state of the process 700 is changed. For example, if the exposures of the RGB sensor 116 and the NIR sensor 114 were previously equal and now the exposure of the RGB sensor 116 is greater than the exposure of the NIR sensor 114, the process 700 proceeds to block 730. Alternatively, if the exposure of the RGB sensor 116 is less than the exposure of the NIR sensor 114, the process 700 proceeds to block 726. For example, if the exposure of the RGB sensor 116 was previously greater than the exposure of the NIR sensor 114 and now the exposure of the RGB sensor 116 is less than the exposure of the NIR sensor 114, the process 700 proceeds to block 726. Alternatively, if the exposure of the RGB sensor 116 is now equal to the exposure of the NIR sensor 114, the process 700 proceeds to block 728. For example, if the exposure of the RGB sensor 116 was previously less than the exposure of the NIR sensor 114 and now the exposure of the RGB sensor 116 is greater than the exposure of the NIR sensor 114, the process 700 proceeds to block 730. Alternatively, if the exposure of the RGB sensor 116 is now equal to the exposure of the NIR sensor 114, the process 700 proceeds to block 728. Accordingly, for each frame, the exposures of the NIR sensor 114 and the RGB sensors 116 are compared and the delays and maximum frame rates are updated accordingly. The process 700 continues and/or repeats for each frame until image capture is complete.

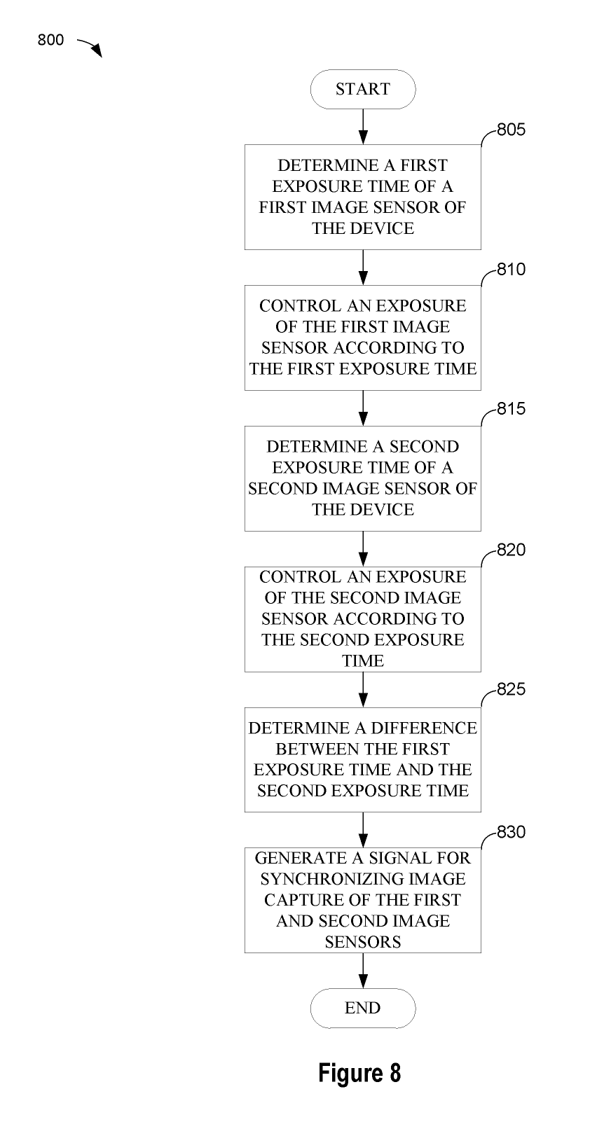

FIG. 8 is a flowchart illustrating an example of a method 800 for controlling and synchronizing asymmetric sensors in the image capture device 102 of FIG. 1, according to an exemplary embodiment. For example, the method 800 could be performed by the camera 302 illustrated in FIG. 3. Method 800 may also be performed by one or more of the components of the camera 302 (e.g., the image processor 320 or the device processor 350). A person having ordinary skill in the art will appreciate that the method 800 may be implemented by other suitable devices and systems. Although the method 800 is described herein with reference to a particular order, in various implementations, blocks herein may be performed in a different order, or omitted, and additional blocks may be added.

The method 800 begins at operation block 805 with the camera 302 determining a first exposure time of a first image sensor (e.g., RGB sensor 116 or the NIR sensor 114 of FIGS. 1 and 3) of the camera 302. Specifically, the image processor 320, the device processor 350, the timing adjustment module 355, and/or the AEC module 360 may determine an amount of time that is required for the exposure of the first image sensor (e.g., size, pixel count, etc.). In some embodiments, the first exposure time may be dependent on characteristics of the first image sensor. At operation block 810, the image processor 320, the device processor 350, and/or the AEC module 360 controls an exposure of the first image sensor according to the first exposure time. In some embodiments, controlling the exposure may include controlling a shutter or similar component of the camera 302.

At operation block 815, the camera 302 determines a second exposure time of a second image sensor (e.g., the RGB sensor 116 or the NIR sensor 114 of FIGS. 1 and 3) of the camera 302. Specifically, the image processor 320, the device processor 350, the timing adjustment module 355, and/or the AEC module 360 may determine an amount of time that is required for the exposure of the second image sensor. In some embodiments, the second exposure time may be dependent on characteristics of the second image sensor (e.g., size, pixel count, etc.). At operation block 820, the image processor 320, the device processor 350, and/or the AEC module 360 controls an exposure of the second image sensor according to the second exposure time. In some embodiments, controlling the exposure may include controlling a shutter or similar component of the camera 302.

At operation block 825, the camera 302 determines a difference between the first exposure time and the second exposure time. Specifically, the image processor 320, the device processor 350, the timing adjustment module 355, and/or the AEC module 360 may compare the first exposure time to the second exposure time. Based on the determined difference, at block 830, the camera 302 generates a signal for synchronizing image capture by the first image sensor with image capture by the second image sensor based on the determined difference between the first exposure time and the second exposure time. Specifically, the image processor 320, the device processor 350, the timing adjustment module 355, and/or the AEC module 360 may generate the signal to synchronize image capture between the two image sensors.

An apparatus for capturing images may perform one or more of the functions of method 800, in accordance with certain aspects described herein. In some aspects, the apparatus may comprise various means for performing the one or more functions of the flow diagram 600 and/or process 700. For example, the apparatus may comprise means for determining a first exposure time of a first image sensor of the device. In certain aspects, the means for determining a first exposure time can be implemented by one or more of the image processor 320, the device processor 350, the timing adjustment module 355, and/or the AEC module 360 of FIG. 3. In certain aspects, the means for determining a first exposure time can be configured to perform the functions of block 805 of FIG. 8.

The apparatus may comprise means for controlling an exposure of the first image sensor according to the first exposure time. In some aspects, the means for controlling an exposure of the first image sensor can be implemented by one or more of the image processor 320, the device processor 350, the timing adjustment module 355, and/or the AEC module 360 of FIG. 3. In certain aspects, the means for controlling an exposure of the first image sensor can be configured to perform the functions of block 810 of FIG. 8.

The apparatus may comprise means for determining a second exposure time of a second image sensor of the device. In certain aspects, the means for determining a second exposure time can be implemented by one or more of the image processor 320, the device processor 350, the timing adjustment module 355, and/or the AEC module 360 of FIG. 3. In certain aspects, the means for determining a second exposure time can be configured to perform the functions of block 815 of FIG. 8.

The apparatus may comprise means for controlling an exposure of the second image sensor according to the second exposure time. In some aspects, the means for controlling an exposure of the second image sensor can be implemented by one or more of the image processor 320, the device processor 350, the timing adjustment module 355, and/or the AEC module 360 of FIG. 3. In certain aspects, the means for controlling an exposure of the second image sensor can be configured to perform the functions of block 820 of FIG. 8.

The apparatus may comprise means for determining a difference between the first exposure time and the second exposure time. In certain aspects, the means for determining a difference can be implemented by one or more of the image processor 320, the device processor 350, the timing adjustment module 355, and/or the AEC module 360 of FIG. 3. In certain aspects, the means for determining a difference can be configured to perform the functions of block 825 of FIG. 8.

The apparatus may comprise means for generating a signal for synchronizing image capture by the first image sensor with image capture by the second image sensor based on the determined difference between the first exposure time and the second exposure time. In certain aspects, the means for generating the signal can be implemented by one or more of the image processor 320, the device processor 350, the timing adjustment module 355, and/or the AEC module 360 of FIG. 3. In certain aspects, the means for generating a signal can be configured to perform the functions of block 830 of FIG. 8.

Furthermore, in some aspects, the various means of the apparatus for capturing images may comprise algorithms or processes for performing one or more functions. For example, according to these algorithms or processes, the apparatus may obtain information regarding an amount of time required to expose a first image sensor. The apparatus may obtain this information from information stored about the first image sensor or from feedback of the first image sensor. This may apply to each of the image sensors of the apparatus (e.g., both the first and second image sensors). This information may be used to control exposures of the first and second image sensors to ensure that the image sensors are fully exposed without being overexposed. The apparatus may use the determined or obtained exposure times for the first and second image sensors to determine a difference between the exposure times. This difference may be used to synchronize exposure of the first and second image sensors by generating a synchronization signal that may be communicated to the first or second image sensor, dependent upon which image sensor exposure needs to be advanced or delayed.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. An apparatus for capturing images, comprising:
a first image sensor;
a second image sensor; and
at least one controller coupled to the first image sensor and the second image sensor, the at least one controller configured to:
determine a first exposure time of the first image sensor,
control an exposure of the first image sensor according to the first exposure time,
determine a second exposure time of the second image sensor,
control an exposure of the second image sensor according to the second exposure time,
determine a difference between the first exposure time and the second exposure time; and
generate a signal for synchronizing image capture by the first image sensor with image capture by the second image sensor based on the determined difference between the first exposure time and the second exposure time.

2. The apparatus of claim 1, wherein the at least one controller is further configured to generate a delay value according to the signal for synchronizing image capture by the first image sensor with image capture by the second image sensor, wherein the delay value comprises a time period by which the exposure of one of the first and second image sensors is delayed.

3. The apparatus of claim 1, wherein the at least one controller comprises a first controller that determines the first exposure time of the first image sensor and controls the exposure of the first image sensor according to the first exposure time and a second controller that determines the second exposure time of the second image sensor and controls the exposure of the second image sensor according to the second exposure time.

4. The apparatus of claim 1, wherein the first exposure time of the first image sensor is determined based on a first local automatic exposure control independent of the second exposure time of the second image sensor being determined based on a second local automatic exposure control.

5. The apparatus of claim 4, further comprising an automatic exposure control (AEC) module configured to perform the first local automatic exposure control of the first image sensor and the second local automatic exposure control of the second image sensor independent from each other.

6. The apparatus of claim 1, wherein the first image sensor is configured as a master sensor and the second image sensor is configured as a slave sensor and wherein the signal for synchronizing the first and second image sensors is generated to synchronize the slave sensor to the master sensor.

7. The apparatus of claim 1, wherein the controller is configured to generate the signal for synchronizing image capture by the first image sensor with image capture by the second image sensor to include a delay value for aligning the exposure of the first image sensor and the exposure of the second image sensor at one of a beginning portion of a line, a middle portion of the line, and an end portion of the line being captured by the first and second image sensors.

8. The apparatus of claim 1, wherein the first image sensor is a red-green-blue (RGB) sensor and wherein the second image sensor is a near-infrared (NIR) sensor.

9. The apparatus of claim 1, wherein the first image sensor has a first resolution or size, wherein the second image sensor has a second resolution or size, and wherein the first resolution or size is different from the second resolution or size.

10. A method of capturing images via an image capture device, the method comprising:
determining a first exposure time of a first image sensor of the device;
controlling an exposure of the first image sensor according to the first exposure time;
determining a second exposure time of a second image sensor of the device;
controlling an exposure of the second image sensor according to the second exposure time;
determining a difference between the first exposure time and the second exposure time; and
generating a signal for synchronizing image capture by the first image sensor with image capture by the second image sensor based on the determined difference between the first exposure time and the second exposure time.

11. The method of claim 10, further comprising generating a delay value according to the signal for synchronizing image capture by the first image sensor with image capture by the second image sensor, wherein the delay value comprises a time period by which the exposure of one of the first and second image sensors is delayed.

12. The method of claim 10, wherein the determining of the first exposure time of the first image sensor and the controlling of the exposure of the first image sensor according to the first exposure time are performed by a first controller and wherein the determining of the second exposure time of the second image sensor and the controlling of the exposure of the second image sensor according to the second exposure time are performed by a second controller.

13. The method of claim 10, wherein the first exposure time of the first image sensor is determined based on a first local automatic exposure control independent of the second exposure time of the second image sensor being determined based on a second local automatic exposure control.

14. The method of claim 13, further comprising performing the first local automatic exposure control of the first image sensor and the second local automatic exposure control of the second image sensor independent from each other.

15. The method of claim 10, wherein the first image sensor is configured as a master sensor and the second image sensor is configured as a slave sensor and wherein the signal for synchronizing the first and second image sensors is generated to synchronize the slave sensor to the master sensor.

16. The method of claim 10, further comprising generating the signal for synchronizing image capture by the first image sensor with image capture by the second image sensor to include a delay value for aligning the exposure of the first image sensor and the exposure of the second image sensor at one of a beginning portion of a line, a middle portion of the line, and an end portion of the line being captured by the first and second image sensors.

17. The method of claim 10, wherein the first image sensor is a red-green-blue (RGB) sensor and wherein the second image sensor is a near-infrared (NIR) sensor.

18. The method of claim 10, wherein the first image sensor has a first resolution or size, wherein the second image sensor has a second resolution or size, and wherein the first resolution or size is different from the second resolution or size.

19. An apparatus for capturing images, the apparatus comprising:
means for determining a first exposure time of a first image sensor of the device;
means for controlling an exposure of the first image sensor according to the first exposure time;
means for determining a second exposure time of a second image sensor of the device;
means for controlling an exposure of the second image sensor according to the second exposure time;
means for determining a difference between the first exposure time and the second exposure time; and
means for generating a signal for synchronizing image capture by the first image sensor with image capture by the second image sensor based on the determined difference between the first exposure time and the second exposure time.

20. The apparatus of claim 19, further comprising means for generating a delay value according to the signal for synchronizing image capture by the first image sensor with image capture by the second image sensor, wherein the delay value comprises a time period by which the exposure of one of the first and second image sensors is delayed.

21. The apparatus of claim 19, wherein the means for determining the first exposure time of the first image sensor and the means for controlling the exposure of the first image sensor according to the first exposure time comprise a first controller and wherein the means for determining the second exposure time of the second image sensor and means for controlling the exposure of the second image sensor according to the second exposure time comprise a second controller.

22. The apparatus of claim 19, wherein the first exposure time of the first image sensor is determined based on a first local automatic exposure control independent of the second exposure time of the second image sensor being determined based on a second local automatic exposure control.

23. The apparatus of claim 22, further comprising a means for performing the first local automatic exposure control of the first image sensor and the second local automatic exposure control of the second image sensor independent from each other.

24. The apparatus of claim 19, wherein the first image sensor is configured as a master sensor and the second image sensor is configured as a slave sensor and wherein the signal for synchronizing the first and second image sensors is generated to synchronize the slave sensor to the master sensor.

25. The apparatus of claim 19, wherein the means for generating a signal for synchronizing image capture configured to generate the signal for synchronizing image capture to include a delay value for aligning the exposure of the first image sensor and the exposure of the second image sensor at one of a beginning portion of a line, a middle portion of the line, and an end portion of the line being captured by the first and second image sensors.

26. The apparatus of claim 19, wherein the first image sensor is a red-green-blue (RGB) sensor and wherein the second image sensor is a near-infrared (NIR) sensor.

27. The apparatus of claim 19, wherein the first image sensor has a first resolution or size, wherein the second image sensor has a second resolution or size, and wherein the first resolution or size is different from the second resolution or size.

28. The apparatus of claim 19, wherein the means for determining a first exposure time of a first image sensor, the means for controlling an exposure of the first image sensor according to the first exposure time, the means for determining a second exposure time of a second image sensor of the device, the means for controlling an exposure of the second image sensor according to the second exposure time, the means for determining a difference between the first exposure time and the second exposure time, and the means for generating a signal for synchronizing image capture by the first image sensor with image capture by the second image sensor comprise a processor.

29. A non-transitory, computer readable storage medium, comprising code executable to:
determine a first exposure time of a first image sensor of the device;
control an exposure of the first image sensor according to the first exposure time;
determine a second exposure time of a second image sensor of the device;
control an exposure of the second image sensor according to the second exposure time;
determine a difference between the first exposure time and the second exposure time; and
generate a signal for synchronizing image capture by the first image sensor with image capture by the second image sensor based on the determined difference between the first exposure time and the second exposure time.
